(19) United States
(12) Patent Application Publication
(10) Pub. No.: US 2011/0070326 A1
(43) Pub. Date: Mar. 24, 2011

(54) OREGANO EXTRACT AND ITS COMPONENTS FOR ENHANCING VIGILANCE

(75) Inventors: Ann Fowler, Rheinfelden (CH); Regina Goralczyk, Grenzach-Wyhlen (DE); Claus Kilpert, Mannheim (DE); Hasan Hohajeri, Egg b. Zurich (CH); Goede Schueler, Weil am Rhein (DE); Jonas Wittwer, Zurich (CH)

(73) Assignee: DSM IP ASSETS B.V., Heerlen (NL)

(21) Appl. No.: 12/847,543

(22) Filed: Jul. 30, 2010

Related U.S. Application Data
(63) Continuation-in-part of application No. 12/375,582, filed on Nov. 4, 2009.
(60) Provisional application No. 61/154,023, filed on Feb. 20, 2009.
(60) Provisional application No. 61/222,213, filed on Jul. 1, 2009.

(30) Foreign Application Priority Data
Aug. 9, 2006 (EP) 0 601 6659.2
Feb. 19, 2010 (EP) PCT/EP2010/052115

(51) Int. Cl. A23L 1/30; A23K 1/00

(52) U.S. Cl. 426/2; 426/87; 426/648

(57) ABSTRACT

Oregano extract can act as a stimulant, yet it does not interfere with sleep patterns or induce nervousness the way many stimulants such as caffeine can. It also has the benefits of promoting improved vigilance, improving attention and ability to focus on a task, and improving general alertness.

This application is a continuation-in-part of U.S. Ser. No. 12/375,582 filed Aug. 9, 2007, which is a National Phase filing of PCT/EP2007/007053 (WO 2008/017484) filed Aug. 9, 2007, which claims priority to European Patent Application 0 601 6659.2, filed Aug. 9, 2006; and PCT/EP2010/052115, filed Feb. 19, 2010, which claims priority from U.S. Provisional Patent Application 61/154,023 and U.S. Provisional Patent Application 61/222,213, filed Jul. 1, 2010, all of which are hereby incorporated by reference.

### FIELD OF THE INVENTION

This invention relates to the use of oregano extract and its active ingredients to increase a person's ability to stay focused, alert, and vigilant without the accompanying nervousness or agitation commonly experienced when taking stimulants (such as caffeine).

### BACKGROUND OF THE INVENTION

As people in Western society experience a longer lifespan, the need to remain independent will continue to grow. In order to stay independent and to ensure healthy living in later years, people have to remain healthy, both in body and in mind.

As we grow older, people often experience diminished attention, information processing speed, flexibility and short-term memory. However, even the non-elderly segment of the population can often experience similar memory problems when faced with stress and information overload due to life experiences such as starting a new job, overwhelming work deadlines, school competitions or exhausting and tiring social interactions.

Natural ingredients can be of help for people to naturally fight tiredness and to increase attention and vigilance. Among these natural ingredients, coffee is one of the most consumed. Coffee was shown to increase wakefulness and motor activity and to improve alertness and attention that can improve mental and work performance. However, coffee has also side-effects depending on the consumer and the amount of coffee intake. Sensitive drinkers who consume more than a few cups of coffee at a time might experience insomnia, irritability, hand tremors, restlessness, nervousness, headaches, extra heartbeats and have a difficult time concentrating. Other side effects include a temporary rise in blood pressure, breathing rate and metabolism.

The main neurotransmitters are serotonin, dopamine, noradrenaline, acetylcholine, glutamate, gamma-amino-butyric acid. Those neurotransmitters of particular relevance to mood-related disorders are serotonin, noradrenaline, and dopamine. Increase in neurotransmission is achieved by increasing the concentration of the neurotransmitter in the synaptic cleft thus making it available for increased or prolonged neurotransmission through inhibition of re-uptake into the pre-synaptic nerve end, or by preventing neurotransmitter catabolism by inhibition of degrading enzymes such as monoamine oxidase A and B.

WO 95/05838 discloses the use of a plant volatile oil derivable from clove, nutmeg, pepper, thyme, paprika, oregano, maharani, basil and French tarragon or a constituent thereof (e.g. linalool, thujone, camphene, carvacrol and thymol from thyme oil) to combat deleterious changes in the peripheral nervous system (such as morphology, structure an quantity of tissue). There is no teaching of the use of these substances to affect biochemical processes in the brain.

WO 01/45780 discloses the use of light therapy, optionally in combination with aromatherapy, whereby Oreganum is one of the possible ingredients, to treat sleeping disorders combined with nervousness. Thus, the composition is administered via olfactory means.

It would therefore be desirable to identify natural ingredients having the positive stimulating effects of coffee, but without the adverse side-effects.

### DETAILED DESCRIPTION OF THE INVENTION

It has been found, in accordance with this invention, and based on electroencephalogram (EEG) and evoked potential testing, that administration of an oregano extract and/or its active ingredients results in a state of relaxation which is combined with vigilance, i.e., wakefulness, alertness, the ability to focus, and/or stimulates attention.

Another aspect of this invention is the use of oregano extract and/or its active ingredients to enhance vigilance, i.e. wakefulness, alertness, and focus in a subject. Another aspect of this invention is a food, nutraceutical, or pharmaceutical composition that enhances vigilance, i.e. wakefulness, alertness, and the ability to focus comprising an effective amount of oregano extract and/or its active ingredients. Another aspect is a method of enhancing vigilance comprising administering an effective amount of oregano to a subject and observing an enhanced vigilance.

Another embodiment of this invention is a method of achieving a relaxed state while staying vigilant, i.e. wakeful, alert, and focused comprising ingesting an oregano extract in an amount sufficient to increase alpha-1 and beta-1 waves, accompanied by awareness of achieving this vigilant state.

Another aspect of this invention is a method of increasing P300 peak amplitude comprising administration of oregano extract or its active ingredients, and observing the increase.

Another aspect of this invention is the ingestion of oregano extract as a food ingredient or food supplement so that after ingestion, a person will feel relaxed, yet alert, vigilant, focused, and attentive, and appreciate the altered feeling. A further aspect of this invention is a kit comprising the oregano extract or its active ingredients, and printed material containing instructions for using it to increase vigilance.

Another aspect of this invention is a method of improving vigilance comprising administering oregano extract, and observing enhanced vigilance.

Another aspect of this invention is a nutraceutical, pharmaceutical, food comprising oregano extract or its active ingredients supplement which can induce wakefulness, yet not interfere with sleep patterns. Administering the nutraceutical, pharmaceutical or food, and noticing or appreciating a vigilant state is also an aspect of this invention.

### BRIEF DESCRIPTION OF THE FIGURES

FIG. 1 shows Pharmaco-EEG inter-kinetic maps for absolute energy, alpha-1 and beta-1 waves, for oregano extract 120 mg compared with placebo. Significant changes are visible for alpha-1 and beta-1 waves after 1 hour. Significant ranges of positive changes in the direction of oregano extract are indicated according to the grey-scale.

FIG. 2 is the S300 mapping of integrated P300 response (statistically significant maps) showing significant positive changes (p<0.01) of P300 amplitudes for the 30 mg oregano extract dose between 2-6 hours after intake and significant positive changes (p<0.01) of amplitudes for the 60 mg oregano extract dose at 2 hours after intake compared to placebo.

FIG. 3 shows P300 peak amplitudes (in %) for the oregano extracts and placebo in relation to pre-dose (baseline) on the vertex lead (central electrode on the head). There is a significant increase of P300 amplitude with 60 mg oregano extract compared to placebo and compared with baseline 2 hours after intake (indicated with asterisk).

FIG. 4 shows P300 peak latency changes (in milliseconds) of oregano extract versus placebo. A trend of oregano extract to decrease P300 peak latency 1 hour after intake (10 ms reduction) can be observed.

FIG. 5 shows graphs of sleep profile parameters. None of the parameters were significantly changed.

FIG. 6 shows the effects of oregano extract on motion (Ordinate) in rats. Changes in motion in percent of the baseline values depicted for the whole time course of 5 hours after drug administration. Average values are given +-S.E.M. Statistical comparison to the results with corn oil was determined using the Wilcoxon, Mann, Whitney U-test. Error probability is marked by stars: *=p<0.10, **=p<0.05.

### DEFINITIONS

The terms “impaired neurotransmission” and “reduced neurotransmission” are used interchangeably throughout the present application. They are used in the present application in accordance with their meaning well-known to the person skilled in the art, and relate to a state of deregulation of neurotransmission, which may occur at the level of neurotransmitter biosynthesis, processing, storage, release, re-uptake and receptor binding. Impaired neurotransmission, in particular a reduction of neurotransmission, may manifest itself in animals including humans as a disturbance of behavior, emotions, mood and thinking processes, for example, in one of various types of depression.

The term “oregano extract and/or its volatile components” is meant to comprise not only complete mixtures of extractable compounds but also only volatile components of the plant taken alone or in any combination with each other. The most important volatile components of oregano extracts in accordance with the present invention are: carvacrol, thymol, thymoquinone and thymoquinol. Thus, “oregano extract and/or its active ingredients” means that oregano extract, carvacrol, thymol, thymoquinone, thymoquinol or mixtures of two or more of the foregoing components may be present.

Examples of additional volatile components of oregano extracts are: 4-tert-butylphenol; 2,3-diisopropyl-5-methylphenol; 2,4-diisopropyl-3-methylphenol; 2,4-diisoprpyl-5-methylphenol; 2,5-diisopropyl-3-methylphenol; 2,5-diisopropyl-4-methylphenol; 2,6-diisopropyl-3-methylphenol and p-ment-3-en-1-ol.

The expression “oregano extracts” of the present invention does not encompass teas or hot aqueous extracts made from fresh or dried leaves or any other parts of Oregano species, as teas will only contain trace amounts of the volatiles. Extracts obtained by steam distillation are, however, in the scope of the present invention. Such extracts generally contain volatile compounds that are not readily degraded. Distilled oils contain hardly any thymoquinone and other volatiles, since they degrade more rapidly during steam distillation. However, they can contain high amounts of carvacrol. SFCO2 extracts are especially preferred for their stability (up to 5 years in closed containers).

The term “vigilance” encompasses one or more of the following traits: wakefulness, alertness, attentiveness, concentration and focus. Specifically, one's ability to increase and/or maintain concentration is enhanced, along with the ability to ignore surrounding signals not of relevance to the situation.

The term “observing enhanced vigilance” means that the observer may either be the person who ingests the active ingredients, or another observer. The observation may be a self-assessment, or may be based on objective measureable criteria.

“Animals” includes humans, and encompasses mammals, fish and birds. Preferred are: humans, pets or companion animals, farm animals, and animals used in the fur industry. “Farm animals” includes: fish, such as salmon and trout, aquaculture animals such as shrimp, pigs, horses, ruminants (cattle, sheep, goats) and poultry (such as geese, chickens, broilers, laying hens, quails, ducks, and turkeys). Preferred are poultry, cattle, sheep, goats and pigs. “Pets” or “companion animals” include dogs, cats, birds, aquarium fish, guinea pigs, (jack) rabbits, hares and ferrets. Dogs and cats are preferred. “Animals used in the fur industry” include minks, foxes, and hares.

“Dietary compositions” includes any type of nutritional product, such as fortified food/feed and beverages, and also includes clinical nutrition products, and dietary supplements.

“Fortification” means that at least an oregano extract or one or more volatile component(s) thereof was added during manufacture of the food/feed or beverage.

“Treatment” also encompasses co-treatment as well as prophylactic treatment.

“Prevention” does not mean that the symptom or disease will never occur (as in this sense no disease can ever be prevented with complete certainty). Prevention, as used throughout this specification and claims means that the risk of suffering or the severity of the suffering is reduced. The term “prevention” also encompasses the reduction of the risk or incidence of developing certain symptoms. “Prevention” can be the prevention of the first occurrence (primary prevention) or the prevention of a reoccurrence (secondary prevention).

One embodiment of the present invention relates to the use of oregano extracts or their volatile components “condition improvers”, i.e. to increase energy in more general terms, especially to increase brain energy production, normal healthy individuals. Moreover, such “condition improvers” are to be used for cognition improvement in general, and especially for maintenance or improvement of attention and concentration, of memory and of the capacity for remembering, of learning ability, of language processing, of problem solving and of intellectual functioning; for improvement of short-term memory; for increasing mental alertness; for increasing the ability to focus and mental sharpness, for enhancing mental vigilance; for reducing mental fatigue; for supporting cognitive wellness, for maintaining balanced cognitive function, for the regulation of hunger and satiety as well as for the regulation of motor activity.

### Increased Vigilance

Assessment of vigilance: Cognitive function and vigilance can be tested by third parties in several ways. Several cognitive tests have been developed and validated which measure different aspects of cognition such as spatial learning (cognitive development) or memory, and these can be used to assess the effects of the oregano extracts of this invention.

However, these tests describe the outcomes of improved cognition, but do not focus on the neurobiological activities. In addition, they often fail to identify small changes in cognitive performance. As an illustration, it is difficult for a third party to measure minor changes occurring in mild cognitive impairment. Further, questionnaires directed to assessing qualities such as vigilance, arousal, alertness and attention are generally not considered an accurate and robust measurement of these states. They are often subject to ethnic/cultural bias interpretation, or can be influenced by the level or quality of education.

Neuron-imaging techniques are one type of less-biased techniques which can give the opportunity to directly investigate the neuronal activity as a response to several stimuli or conditions in different brain areas. For assessing different levels of global brain activation, Electro Encephalograms (EEGs) and Event Related Potentials (ERPs) are the preferred methods because they reflect the temporo-spatial pattern of synchronized cortical neuronal mass activity and are the only noninvasive methods to measure neuronal activity directly and with a sufficient time resolution. The resolution of this method is in milliseconds.

The EEG measures ongoing electrical activity generated by the neurons in the brain resulting in brainwaves of different frequencies. These waves can be divided into several frequency bands, in particular Delta (0.5-3.5 Hz), Theta (4-7.5 Hz), Alpha (8-12.5 Hz), and Beta (13-32 Hz). These waves reflect the state of brain function that the person experiences at the moment of the recording:
delta waves normally occur in deep sleep;
theta waves are seen in connection with intuition, daydreaming and fantasizing and therefore reflect the state between wakefulness and sleep;
alpha waves reflect a state of relaxation and alertness and are the brain's most important waves associated with learning and using information; and
beta waves are associated with mental activity, alertness, problem solving, judgment, decision making and processing information, all components of “vigilance”.

One measurement of ERPs is the “P300” peak. This peak is an evoked potential (e.g., by visual or acoustic stimulus) referred to as a “cognitive” or “event-related response” occurring in the 300 msec latency region with a large positive voltage peak. Attention and state of arousal are the two most important factors in eliciting a P300 response. P300 amplitudes and latencies are used clinically to assess patients with Alzheimer's Disease, Parkinson's Disease, and dementia. Patients with these neurodegenerative disorders tend to have prolonged P300 latencies, believed to be related to changes in neurotransmitters. P300 latencies have been shown to increase (while amplitudes decrease), with decreases in cognitive function. Also, healthy people who are bored tend to show a lengthening of P300 latency and a shortening of P300 amplitude.

It has been found, it accordance with this invention that oregano extract and its active ingredients are able to significantly increase alpha-1 and beta-1 EEG parameters in the resting condition.

An increase in alpha activity has been associated with relaxation, increased creativity, increased performance under stress and improved learning and concentration, as well as decreased anxiety. (Eschenauer et al 2006 Am J Syst Pharm 63:26-30; Boutcher et al 1988 Psychophysiology 25: 696-702). An increase in beta activity is related to higher cortical activation (Kubitz et al 1996 Res Q Exert Sport 67: 91-96), an increased state of alertness (Porjesz et al 2002 BiolPhychol 61:229-48) and cognitive processing (Karrasch et al 2004 Neurosci Lett 366: 18-23).

Thus, in accordance with this invention, oregano extract or its active ingredients can improve relaxation, increase creativity, increase performance under stress, improve concentration, and decrease anxiety as it increases alpha-1 waves. By increasing beta-1 waves, oregano extract or its active ingredients can increase alertness, concentration and thus increase vigilance. The increase in alpha-1 and/or beta-1 waves may be observed by a third party, or may be self-assessed, i.e. the individual who ingests the oregano extract may appreciate any or all of the following manifestations of increased alpha-1 and/or beta-1 brain waves: an improved relaxation, increased creativity, increased performance under stress, improved concentration and/or decreased anxiety.

Also it has been shown in accordance with this invention, that oregano extract and its active ingredients can significantly increase the surface P300 peak amplitudes (S300) as well as the P300 peak amplitudes on the vertex lead. The oregano extract also decreases the P300 peak latencies.

An increase of P300 peak amplitude has been related to a higher amount of selective attention (van Nunen et al 1994 Acta Phychiatr Belg 94: 96-97), whereas shorter P300 peak latencies have been related to superior cognitive performance by a faster processing time for the discrimination, referencing, and evaluation of stimuli (van Nunen, supra; Hansenne 2000 Neurophysiol Clin 30: 191-210; Emmerson et al 1989 Exp. Aging Res 15:151-9).

Another aspect of this invention is the use of oregano extract to compensate for the daily circadian decline in attention, wakefulness and alertness (vigilance) e.g., before and after lunch (mid day). It was also found, in accordance with this invention, that the subjects who received oregano extract did not experience the decrease of attention around midday as is often felt by many people. According to our experiments, the placebo group experienced a decrease of selective attention, alertness, wakefulness and focus on their assigned tasks towards lunchtime as measured by a reduction of P300 peak amplitudes on the vertex lead. However, in the group receiving the oregano extract, this was not observed. The subjects receiving oregano extract showed an increase of attention of 7% compared to the attention in the early morning.

A circadian decline of attention towards midday has also been shown by Kirkcaldy 1984 Eur J Appl Physiol Occup Physiol 52: 375-9. In the Kirkcaldy study, subjects reported to feel less activated and less alert around midday (between 11:00 AM and about 2:00 PM). Thus, another aspect of this invention is a method of avoiding a decrease of attention and/or alertness at midday by administering an effective amount of oregano extract between 11:00 AM and 2:00 PM, or not later than one hour after a lunch time meal, and observing that attention and/or alertness does not decline.

Therefore, these results indicate that oregano extract supports a state of relaxation, which is combined with wakefulness, alertness and focus.

Thus, one aspect of this invention is a method of increasing the likelihood that one can pay attention in a boring situation comprising ingesting oregano extract and remaining attentive. Specifically, this would apply to staying alert at meetings, during entertainment events (i.e. watching TV, movies, etc) or other situations requiring that the participant remain passive and subject to boredom or having one's mind wander.

Yet another aspect of this invention is a method for preventing or treating disorders connected to impaired neurotransmission in humans by increasing the plasma level of carvacrol to at least 10 ng/ml in humans, preferably by increasing the plasma level of carvacrol to within the range of 10 ng/ml to 51000 ng/ml in humans. The plasma level may be measured as described in the Examples.

### Veterinary Uses

In another embodiment of the present invention, the oregano extracts or their volatile components, are administered to animals, including pets and companion animals. It is especially preferred for animals which rely on their intelligence, for example: those which perform tricks or routines, such as those used in the circus, TV or film industries; for horses performing in dressage or other such events; animals such as guide dogs; and other animals which aid sick/injured/disabled people; rescue animals, etc.

Appropriate dosages can be determined based on the human dosages and adjusted according to accepted practice.

Oregano Extracts and their Volatile Components

The oregano extracts may be of any origin from a plant (whole plant or parts thereof) belonging to the genera Origanum such as Origanum vulgare or Oreganum minutiflorum and Thymus such as Thymus vulgaris in form of a concentrate of extractable compounds, especially volatile compounds. Further examples of plants from the genus Origanum covered by the term “oregano”, are O. majorana, O. dictamus, O. creticum, O. x majoricum, O. aureum, O. compactus, O. syriaca, O. tytthantum, O. heracleoticum, O. smyrnaeum and O. virens. Further examples of plants from the genus Thymus covered by the term “oregano” are T. herbus-barona, T. citriodorus, T. mastichiana, T. pulegioides, T. serpyllum, T. pallasianus and T. praecox. The concentrate may still contain solvents used for the extraction, be free from them or may be transferred to specific carrier materials. The extracts may be obtained in accordance with methods well-known in the art, e.g., by (an) extraction with solvents like methanol, ethanol, ethyl acetate, diethylether, n-hexane, methylene chloride, or with supercritical fluids like carbon dioxide (pure or in mixture with other solvents such as alcohols) or dinitrogen oxide, (b) hydrodistillation for obtaining essential oils or (c) extraction/distillation with hot gases like nitrogen.

Preferably oregano extracts are used that are obtained by an extraction with the use of supercritical carbon dioxide. Such extracts have the advantage that they do not contain any organic solvents, no proteins and no heavy metals. If desired, an extraction with supercritical carbon dioxide is followed by a second supercritical fluid CO2-extraction step to remove waxes and selectively enrich the volatiles.

The oregano extracts or their volatile components can be of natural or synthetic or mixed (viz. partly natural, partly synthetic) origin, i.e., they can, apart from being obtained by extraction of plants and fractionation, be chemically synthesized and, if desired, mixed together in any desired quantities. They can be prepared and used in any desired purities and concentrations, e.g. as solutions containing them in concentrations as low as, e.g., 10% (w/w) or less, or up to nearly 100% (w/w).

Preferred are oregano extracts containing a high proportion of at least one of their volatile components. More preferred are oregano extracts containing at least a total of 70 weight-% of volatile components as mentioned above, based on the total weight of the extract. Completely natural oregano extracts may be fortified with at least one specific volatile component thereof.

Preferred oregano extracts in the context of the present invention are those wherein:

the oregano extract comprises at least 30 weight-% of carvacrol;
the oregano extract comprises at least 50 weight-% of carvacrol;
more preferably wherein the oregano extract comprises at least 60 weight-% of carvacrol;
and most preferably wherein the oregano extract comprises at least 65 weight-% of carvacrol, based on the weight of the oregano extract.

Also preferred are oregano extracts are oregano extracts which comprise thymoquinone in an amount in the range of from 0 to 30 weight-%;

preferably wherein the oregano extract comprises at least 1 weight-% of thymoquinone; more preferably wherein the oregano extract comprises at least 2 weight-% of thymoquinone;
even more preferably wherein the oregano extract comprises at least 5 weight-% of thymoquinone; and
most preferably wherein the oregano extract comprises thymoquinone in a range of from 5 to 30 weight-%, based on the weight of the oregano extract.

Other preferred oregano extracts are those wherein the oregano extract comprises at least 50 weight-% of carvacrol and from 0 to 25 weight-%, of thymoquinone;

preferably wherein the oregano extract comprises at least 50 weight-% of carvacrol and at least 1 weight-% of thymoquinone;
more preferably wherein the oregano extract comprises at least 55 weight-% of carvacrol and at least 2 weight-% of thymoquinone,
even more preferably wherein the oregano extract comprises at least 60 weight-% of carvacrol and at least 5 weight-% of thymoquinone, and
most preferably wherein the oregano extract comprises at least 65 weight-% of carvacrol and thymoquinone in a range of from 5 to 25 weight-%, based on the weight of the oregano extract.

Preferred ratios of thymoquinone:carvacrol range from 1:50 to 1:2, preferably 1:30 to 1:5, and more preferably from 1:20-1:10.

Also preferred are the methods where single volatile components or their mixtures are used, whereby the volatile components are selected from the group consisting of carvacrol, thymoquinone, p-cymene, thymoquinol, limonene, linalool, borneol, 4-terpineol, thymol and caryophyllene. Preferably the volatile components are selected from the group consisting of carvacrol, thymoquinone and p-cymene, more preferably wherein the volatile components carvacrol and/or thymoquinone, most preferably wherein the volatile component is carvacrol. Ratios of thymoquinone to carcacrol can range from 1:50 to 1:2; preferably from 1:30 to 1:5, and more preferably from 1:20 to 1:10. It is also possible to use extracts with a low thymoquinone content and high carvacol content. For these extracts, ratios of 1:100 to 1:200 can be used.

Even more preferred are oregano extracts that do not contain: a hydrophilic extract, an essential amount of one of the following constituents: rosmarinic acid, eugenol, eugenol salts, eugenol isomers, yeast cell walls or 1-piperoylpiperidine. An “essential amount” as used herein the total amount of any of these ingredients, if present at all. is preferably below 0.5 weight-%, more preferably below 0.2 weight-%, even more preferably below 0.1 weight-%, based on the total weight of said oregano extract or oregano material or the volatile component(s).

Further, certain combinations of plant extracts are not preferred in this invention, such as the combination of oregano extract and: Agaricus blazei, nettle, artichoke, Crataegus, Leonurus, common yarrow, mistletoe, Crataeg, Herba viola tricolor, Scutellariac baicalensis, turmeric, goldthread, and/or barberry.

The composition of the present invention is preferably in the form of nutritional composition, such as fortified food, fortified feed, or fortified beverages, or in form of fortified liquid food/feed for animals including humans.

The dietary and pharmaceutical compositions according to the present invention may be in any galenic form that is suitable for administering to the animal body including the human body, especially in any form that is conventional for oral administration, e.g. in solid form, such as (additives/supplements for) food or feed, food or feed premix, fortified food or feed, tablets, pills, granules, dragées, capsules, and effervescent formulations such as powders and tablets, or in liquid form such as solutions, emulsions or suspensions as e.g. beverages, pastes and oily suspensions. The pastes may be encapsulated in hard or soft shell capsules, whereby the capsules feature e.g. a matrix of (fish, swine, poultry, cow) gelatin, plant proteins or lignin sulfonate. Examples for other application forms are forms for transdermal, parenteral or injectable administration. The dietary and pharmaceutical compositions may be in the form of controlled (delayed) release formulations. The compositions of the present invention are not administered nasally.

The dietary compositions according to the present invention may further contain protective hydrocolloids (such as gums, proteins, modified starches), binders, film forming agents, encapsulating agents/materials, wall/shell materials, matrix compounds, coatings, emulsifiers, surface active agents, solubilizing agents (oils, fats, waxes, lecithins etc.), adsorbents, carriers, fillers, co-compounds, dispersing agents, wetting agents, processing aids (solvents), flowing agents, taste masking agents, weighting agents, jellifying agents, gel forming agents, antioxidants and antimicrobials.

Examples of food are cereal bars, dairy products, such as yoghurts, and bakery items, such as cakes and cookies. Examples of fortified food are cereal bars, and bakery items, such as bread, bread rolls, bagels, cakes and cookies. Examples of dietary supplements are tablets, pills, granules, dragées, capsules and effervescent formulations, in the form of non-alcoholic drinks, such as soft drinks, fruit juices, lemonades, near-water drinks, teas and milk-based drinks, in the form of liquid food, such as soups and dairy products (muesli drinks).

Beverages encompass non-alcoholic and alcoholic drinks as well as liquid preparations to be added to drinking water and liquid food. Non-alcoholic drinks are e.g. soft drinks, sport drinks, fruit juices, vegetable juices (e.g. tomato juice), lemonades, teas and milk-based drinks. Liquid foods are e.g. soups and dairy products (e.g. muesli drinks).

In addition to at least one oregano extract or one of its volatile components the pharmaceutical compositions according to the present invention may further contain conventional pharmaceutical additives and adjuvants, excipients or diluents, including, but not limited to, water, gelatin of any origin, vegetable gums, lignin sulfonate, talc, sugars, starch, gum arabic, vegetable oils, polyalkylene glycols, flavoring agents, preservatives, stabilizers, emulsifying agents, buffers, lubricants, colorants, wetting agents, fillers, and the like. The carrier material can be organic or inorganic inert carrier material suitable for oral/parenteral/injectable administration.

For humans a suitable daily dosage of oregano extracts or their volatile components for the purposes of the present invention may be within the range from 0.001 mg per kg body weight to about 100 mg per kg body weight per day. More preferred is a daily dosage of about 0.01 to about 10 mg per kg body weight, and especially preferred is a daily dosage of about 0.05 to 5.0 mg per kg body weight.

In solid dosage unit preparations for humans, the oregano extract or its volatile components is/are suitably present in an amount from about 0.1 mg to about 1000 mg, preferably from about 1 mg to about 500 mg per dosage unit. For relief of symptoms associated with conditions as mentioned herein, the oregano extract or any of its volatile components is/are taken once or twice per day together with a meal for at least one week and up to 6-12 months. For prevention of occurrence of symptoms associated with conditions as mentioned herein and for the maintenance of a generally relaxed state, consumption on a regular basis is suitable.

In dietary compositions, especially in food and beverages for humans, the oregano extract or its volatile components is/are suitably present in an amount of from about 0.0001 (1 mg/kg) to about 5 weight-% (50 g/kg), preferably from about 0.001% (10 mg/kg) to about 1 weight-%, (10 g/kg) more preferably from about 0.01 (100 mg/kg) to about 0.5 weight-% (5 g/kg), based upon the total weight of the food or beverage. For relief of symptoms associated with conditions as defined above, the food product is taken once or twice per day at least for one to three weeks or on a regular basis, i.e. at least once daily.

In food and drinks in a preferred embodiment of the invention the amount of the oregano extract or its volatile components is/are 10 to 30 mg per serving, i.e. 120 mg per kg food or drink. The food product is taken once or twice per day at least for one to three weeks or preferably on a regular basis of at least once daily.

For animals excluding humans, a suitable daily dosage of an oregano extract or its volatile components, for the purposes of the present invention may be within the range from 0.001 mg per kg body weight to about 1000 mg per kg body weight per day. More preferred is a daily dosage of about 0.1 mg to about 500 mg per kg body weight, and especially preferred is a daily dosage of about 1 mg to 100 mg per kg body weight.

For increasing vigilance, dosages for an adult of average body weight range from 25-200 or 5-300 mg oregano extract or its active ingredients per day; preferably from about 30-180 mg or 15-200 mg per day. The dosage can be adjusted if required. For a nutritional supplement, the dosage may be in the form of a capsule, a tablet, sachets, or any other conventional dosing form as is known in the art. Other preferred dosages include: 30-100 mg/day, 20-150 mg/day, 30-60 mg/day, and 30-120 mg per day.

For optimal vigilance and alertness it is recommended that an adult take a single 60 mg dosage in the morning. Conveniently, the dosage form may be in the form of a capsule. A second 60 mg capsule (or other dosage form, such as a tablet) can be taken at or shortly after lunch, to prevent post lunch decline in the afternoon. Alternatively, one 120 mg capsule can be taken once per day, preferably in the morning. In an alternative embodiment, a 30 mg dose can be taken 3 times a day, i.e. in the morning at lunch and in the late afternoon, if a person wishes to extend their wakefulness in the evening. This application will not cause any sleeplessness in the night.

Alternatively, the dosage may be in the form of a functional food, where the oregano extract is added to various foodstuffs, including beverages.

Suitable oregano extracts are commercially available. One preferred extract is an SFCO2 extract available from Flavex Gmbh, Rehlingen, Germany.

The invention is illustrated further by the following non-limiting examples.

### EXAMPLES

### Example 1

### Preparation of Two O. vulgare Extracts

In the Examples below, “-se” refers to phenol-type oregano extract 1, and “-to” refers to terpineol-type oregano extract 2, both obtained from Flavex, Germany.

Dried leaves of a O. vulgare were milled and extracted with supercritical carbon dioxide. The parameters of extraction were as follows: temperature of 45° C.; working pressure: 300 bar (-to) or 100 bar (-se); 17 kg (-to) and 15 kg (-se) of carbon dioxide per 1 kg of plant material were needed; the extracts were obtained in the separator by throttling the pressure to 60 bar at 30° C. 25 kg (-to) or 50 kg (-se) of plant material respectively yielded 1 kg of extract.

Extract 1 had the following composition (analyzed by Gas Chromatography):

Total content of essential oil was 83% (the remaining parts are plant waxes)

Volatile components: terpinene 0.2%, cymene 2.6%, 4-terpineol 1.5%, thymoquinone, 23%, thymol 0.3%, carvacrol 62%, caryophyllene 1.5%.

Extract 2 (RV141-23) contained 80-90% essential oil with a high content of terpineols including trans beta terpineol 35-50%, cis beta Terpineol 5-10%, 4-Terpineol 8-12%, and a relative small amount of phenols including thymol 5-12%, carvacrol <1%, based on the total content of essential oils.

### Example 2

### Preparation of Oregano Extract 3

Origanum vulgare leaves were extracted with a solvent mixture of methyl tert-butyl ether and methanol with the volume ratio 9:1.

### Example 3

### Preparation and Composition of Oregano Extract 4 Flavex

The oregano leaves were prepared according to Example 1, extract 1. Due to a different harvest lot, the composition was slightly different to extract 1.

Total content of essential oil was 89.5% (the remaining parts are plant waxes) Volatile components: cymene 7.8%, 4-terpineol 1.2%, thymoquinone, 12.1%, thymol 0.22%, carvacrol 68.5%, caryophyllene 1.6%, limonene 0.1%, linalool 0.77%, borneol 2.6%.

### Example 4

### Detailed Composition of Oregano Extracts

Extracts were prepared by steam distillation of oregano leaves.

Composition was as follows:

Method of analysis GC/MS

| | GC/MS | GC/MS | GC/MS |
|---|---|---|---|
| | Carvacrol | Thymoquinone | Thymol |
| | w/w | w/w | w/w |
| Extract 5 (Oregano Dragon Spice) | 61.6 | — | 9.0 |
| Extract 6 (Yafa herbs/Morocco) | 30.7 | — | 21.6 |
| Extract 7 (Aysun/Derial Turkey) | 64.9 | — | 0.3 |

### Example 5

### Serotonin Uptake Inhibition by Oregano Extracts

HEK-293 cells stably expressing the human serotonin re-uptake transporter (hSERT) were obtained from R. Blakely, Vanderbilt University, USA. The cells were routinely grown in Dulbecco's Modified Eagle's Medium, purchased from Bioconcept, Allschwil, Switzerland containing 10% fetal calf serum, penicillin, streptomycin, L-glutamine and the antibiotic G418 and passaged by trypsinisation. 1 day prior to the assay cells were seeded in the above mentioned medium. Immediately prior to the assay the medium was replaced by Krebs-Ringer bicarbonate buffer, purchased from Sigma Chemicals Ltd., supplemented with 35 μM pargyline, 2.2 mM CaCl₂, 1 mM ascorbic acid and 5 mM N-2-hydroxyethylpiperazine-N′-2-ethanesulfonic acid (“Hepes” buffer). Serotonin uptake into the cells was determined by addition of radio-labeled (3H) serotonin (Amersham Biosciences GE Healthcare, Slough, UK) to a concentration of 20 nM, and incubation for 30 minutes at room temperature. Following removal of unincorporated label by gentle washing three times with the above buffer, incorporated serotonin was quantified by liquid scintillation counting.

Serotonin uptake via the transporter was inhibited by the oregano extract in a dose dependent manner. The measured IC₅₀ values for inhibition of serotonin uptake by three oregano extracts are shown in Table 1.

TABLE 1
Table 1: Measured IC₅₀ values for inhibition of serotonin uptake
into transfected HEK-293 cells by oregano extracts 1, 2 and 3,
and its volatile components thymol, carvacrol and thymoquinol.

| | IC₅₀ [μM or μg/ml] for | |
|---|---|---|
| Substance | tritiated serotonin uptake | |
| Oregano Extract 1 | 3.2 | μg/ml ± 1.4 |
| Oregano Extract 2 | 15.31 | μg/ml ± 5.3 |
| Oregano Extract 3 | 66.3 | μg/ml ± 3.0 |
| Oregano Extract 4 | 1.95 | μg/ml ± 0.94 (n = 3) |
| Oregano Extract 5 | 7.8 | μg/ml |
| Oregano Extract 6 | 5.8 | μg/ml |
| Oregano Extract 7 | 4.1 | μg/ml |
| Thymol | 5.0 | μM ± 0.4 |
| Carvacrol | 9.5 | μM |
| Thymoquinol | 26.6 | μM |

Data is shown as mean ± s.e.m., where the IC₅₀ is stated as μM for single compounds and as μg/ml for extracts.

### Example 6

### Monoamine Oxidase Inhibition by Oregano Extract 1

The organic amines p-tyramine or benzylamine were used as substrates for the Monoamine oxidase A (MAO-A) and B (MAO-B) enzymes respectively. The hydrogen peroxide (H₂O₂) produced by this reaction was quantified by reaction with vanillic acid, catalyzed by horse radish peroxidase (HRP).

The reactions were carried out in polystyrene microtitre plates. The MAO enzymes (final concentration 2 U/ml) were mixed with either p-tyramine (Sigma, final concentration 0.5 mM) or benzylamine (Sigma, final concentration 0.5 mM) as appropriate and the chromogenic solution (containing vanillic acid (Fluka), 4-aminoantipyrine (Fluka) and horse radish peroxidase (Sigma), final concentrations 0.25 mM, 0.125 mM and 1 U/ml, respectively) in 0.2 M potassium phosphate buffer pH 7.6. The reactions were followed in a microtitre plate absorbance reader e.g. Spectramax M5 (Molecular Devices Corporation). Absorbance readings at 495 nm were taken every 15 seconds for 40 minutes and the initial reaction velocities calculated by linear regression using SOFTmaxPro (Molecular Devices Corporation).

The effect of oregano extract 1 on the monoamine oxidase enzymes was determined by its inclusion in the assay at a range of concentrations between 0.03 and 100 μM for 10 minutes prior to and during the incubation with substrate. To determine the effect of the compounds on the HRP catalyzed portion of the reaction, the MAO enzyme was replaced by H₂O₂ (Molecular Probes, final concentration 0.2 mM). The reactions containing MAO-A and -B were both inhibited by oregano extract 1 in a dose-dependent manner, whilst the control reaction was unaffected. The measured IC₅₀ values for inhibition of monoamine oxidase activity by oregano extract 1 are shown in Table 2.

TABLE 2
Table 2: Measured IC₅₀ values for inhibition of Monoamine
Oxidase -A and -B enzymes by oregano extract 1.

| | IC₅₀ [μg/ml] for | IC₅₀ [μg/ml] for |
|---|---|---|
| Substance | Inhibition of MAO-A | Inhibition of MAO-B |
| Oregano Extract 1 | 2.7 μg/ml ± 0.8 | 13.4 μg/ml ± 3.6 |
| | s.e.m. n = 2 | s.e.m. n = 2 |

Data is shown as mean ± s.e.m.

### Example 7

### Effect of Oregano Extract 1 in the Primary Observation (Irwin) Test in the Mouse

The method, which detects the first toxic dose, the active dose-range and the principal effects of a test substance on behaviour and physiological function, follows that described by Irwin (Irwin S. 1968 Psychopharma. 13: 222-257).

Mice were administered the test substance and were observed in simultaneous comparison with a control group given vehicle (non-blind conditions). Three treated groups were compared with the same control group at any one time. All animals within a treatment group were observed simultaneously.

Behavioral modifications, physiological and neurotoxicity symptoms, pupil diameter and rectal temperature were recorded according to a standardized observation grid derived from that of Irwin. The grid contains the following items: lethality*, convulsions*, tremor*, Straub*, sedation, excitation, abnormal gait* (rolling, tip-toe), jumps*, motor uncoordination*, writhes*, piloerection*, stereotypes* (sniffing, chewing, head movements), head twitches*, scratching*, respiration*, aggressiveness*, fear, reactivity to touch, muscle tone, loss of righting reflex, ptosis, exophthalmos, loss of grasping, akinesia, catalepsy, loss of traction, loss of corneal reflex, analgesia, defecation, salivation, lacrimation, pupil diameter (Unit= 1/45 mm) and rectal temperature.

Observations were performed 15, 30, 60, 120 and 180 minutes after administration of the test substance and also 24 hours later. The symptoms marked (*) were observed continuously from 0 to 15 minutes after administration. Five mice were studied per group. Oregano 4 extract was solubilized in 3% (v/v) DMSO, 3% (v/v) Tween 80 in saline (0.9% w/v NaCl) and injected into mice intraperitoneally (i.p.).

### Results

Oregano extract 1 at 3 mg/kg did not induce additional behavioural changes, as compared with the vehicle.
At 10 mg/kg, it induced slight sedation in 3 mice and decreased fear from 15 to 30 minutes in all five mice.
At 30 mg/kg, oregano extract 1 induced slight sedation in four or five mice from 15 to 60 minutes, decreased fear in three or four mice from 15 to 60 minutes and decreased muscle tone in one to five mice from 30 to 60 minutes.
At 100 mg/kg, oregano extract 1 induced sedation which was slight-to-marked in four or five mice from 15 to 180 minutes and slight in one mouse at 24 hours. It decreased fear in four or five mice from 15 to 180 minutes, decreased reactivity to touch in four mice from 60 to 180 minutes and decreased muscle tone in three or four mice from 30 minutes to 24 hours.

Thus, oregano extract 1 showed a dose-dependent moderate sedative and relaxant effect and reduced fear.

### Example 8

### Porsolt's Swim Test

The “Behavioral Despair Test” or “Porsolt's Forced Swim Test” is a validated animal model for depression (see Nagatsu, 2004 NeuroTox., 25:11-20, and Porsolt et al., 1977 Arch. Int. Pharmacodyn 229:327-336). It responds to enhancement of the transmission of several neurotransmitters including serotonin, dopamine and noradrenaline.

The test, which detects antidepressant activity, was carried out as described by Porsolt et al supra. Mice which are forced to swim in a situation from which they cannot escape rapidly become immobile. Antidepressants decrease the duration of immobility.

Mice were individually placed in cylinders (Height=24 cm, Diameter=13 cm) containing 10 cm water (22° C.) from which they could not escape. The mice were placed in the water for 6 minutes and the duration of immobility during the last 4 minutes was measured.

15 mice were studied per each of the four groups. The test was performed blind, i.e. the person carrying out the experiment was different from the person injecting the mice and therefore did not know to which of the four groups each mouse belonged.

Oregano extract 1 was evaluated at 3 doses (10, 30 and 60 mg/kg), administered i.p. 30 minutes before the test, and compared with a control group, administered vehicle in the same manner. The thus administered oregano extract 4 was dissolved in vehicle (saline solution containing 3% (v/v) DMSO and 3% (v/v) Tween® 80). Venlafaxine (16 mg/kg, i.p.), as comparison substance, and imipramine (32 mg/kg, i.p.), as reference compound, were administered under the same experimental conditions.

Data were analyzed by comparing the treated groups with the control group using unpaired Student's t tests and are presented in Table 3.

TABLE 3
Reduction of “immobility time” with increasing
concentration of oregano extract 1.

| TREATMENT | DURATION OF IMMOBILITY (s) | |
|---|---|---|
| (mg/kg) | Mean ± | % change |
| i.p., −30 min | s.e.m. | from control |

| | | | |
|---|---|---|---|
| Vehicle | 164.7 ± 7.6 | — | — |
| Oregano extract 1 (10) | 163.7 ± 10.3 | −1% | NS |
| Oregano extract 1 (30) | 137.1 ± 9.5 | −17% | * |
| Oregano extract 1 (60) | 125.6 ± 6.5 | −24% | *** |
| Venlafaxine (16) | 80.1 ± 11.1 | −51% | *** |
| Imipramine (32) | 49.7 ± 7.9 | −70% | *** |

15 mice per group
Student's t-test:
NS = not significant;
* = p < 0.05;
*** = p < 0.001

Thus, oregano extract 1 significantly reduced immobility time compared with the control group, by 17% and 24% in the intermediate and highest dose groups, respectively. Overall, there was a significant dose-dependent effect of oregano extract 1. Imipramine (32 mg/kg i.p.) and venlafaxine (16 mg/kg, i.p.), administered under the same experimental conditions, significantly reduced immobility behavior, as compared with the vehicle control (−70% and −51%, respectively, p<0.001).

These results show that oregano extract 1 (60 mg/kg, i.p.) has a similar efficacy as the tricyclic antidepressant, imipramine, and the SNRI, venlafaxine, in its ability to significantly reduce depression-related behavior.

### Example 9

### Marble Burying Test as Test for Anxiety Like or Obsessive Compulsive Behavior

“Defensive burying” behavior was originally demonstrated by rats burying noxious objects, such as drinking spouts filled with a unpleasant-tasting liquid (Wilkie et al., J. Exp. Anal. Behavior 1979, 31:299-306) or shock prods (Pinel et al 1978, J. Comp. Physiol. Psych. 92:708-712). The marble burying test was devised as a modification of such a test. Poling et al. 1981 J. Exp. Anal. Behavior 1981, 35:31-44) exposed rats to individual cages each containing 25 marbles, daily for 10 or 21 consecutive days. The number of marbles buried, on each day of the 10 d period, or 24 h after the 21 d exposure, were counted. The authors reported that the burying of marbles was not determined by novelty, or due to any noxious stimuli.

Marble burying behavior by mice is reported to be sensitive to a range of minor (e.g. diazepam) and major (e.g. haloperidol) tranquilizers (Broekkamp et al., 1986 Eur J. Pharmacol. 126:223-229), in addition to SSRIs (e.g. fluvoxamine, fluoxetine, citalopram), tricyclic antidepressants (e.g. imipramine, desipramine) and selective noradrenaline uptake inhibitors (e.g. reboxetine), at doses which do not induce sedation. The model may reflect either anxiety-like- or obsessive-compulsive-behavior (see De Boer et al, 2003 Eur, J. Pharma 463: 145-161).

The method applied here follows that described by Broekkamp et al. 1986, supra. Mice (n=15 per treatment group) were individually placed in transparent plastic cages (33×21×18 cm) with 5 cm of sawdust on the floor and 25 marbles (diameter 1 cm) grouped in the centre of the cage. A second, up-tamed, cage served as a lid. The number of marbles covered by sawdust (by at least two-thirds) was counted at the end of the 30-minute test period. Tests were performed by investigators blind to the drug treatment protocol.

Prior to testing, all test cages and marbles were “impregnated” by leaving 10 naive mice in each cage for 15 minutes.

Oregano extract 1 was evaluated at 10, 30 and 60 mg/kg, administered i.p. 30 minutes before the test, and compared with a vehicle control group. Oregano extract 1 was dissolved in a saline solution containing 3% (v/v) DMSO and 3% (v/v) Tween® 80 “vehicle”. The control group were administered vehicle in the same manner, while fluoxetine (32 mg/kg), administered under the same experimental conditions, was used as a reference substance. Data were analyzed by comparing treated groups with vehicle control using unpaired Student's t-tests.

### Results:

TABLE 4
Effects of oregano extract 1 and fluoxetine
in the marble burying test in mice

| | NUMBER OF MARBLES | |
|---|---|---|
| TREATMENT | COVERED BY SAWDUST | |
| (mg/kg) | Mean ± | % change |
| i.p., −30 min | s.e.m. | from control |

| | | | |
|---|---|---|---|
| Vehicle | 21.2 ± 1.6 | — | — |
| Oregano extract 1 (10) | 12.7 ± 2.7 | −40% | * |
| Oregano extract 1 (30) | 5.8 ± 2.6 | −73% | *** |
| Oregano extract 1 (60) | 6.9 ± 2.6 | −67% | *** |
| Venlafaxine (16) | 0.5 ± 0.3 | −98% | *** |
| Fluoxetine (32) | 1.4 ± 1.0 | −93% | *** |

15 mice per group
Student's t-test:
NS = not significant;
* = p < 0.05;
*** = p < 0.001

Oregano extract 1 (10, 30 and 60 mg/kg), administered i.p. 30 minutes before the test, dose-dependently decreased the number of marbles covered, as compared with the vehicle control (−40%, p<0.05, −73%, p<0.001 and −67%, p<0.001, respectively).

Fluoxetine (32 mg/kg i.p.) and venlafaxine (16 mg/kg, i.p.), administered under the same experimental conditions, nearly abolished marble burying, as compared with the vehicle control (−93% and −98%, respectively, p<0.001).

These results show that oregano extract 1 has a similar efficacy as the SSRI, fluoxetine, and SNRI, venlafaxine, in its ability to significantly reduce anxiety/obsessive-compulsive behavior

### Example 10

### Effect of Oregano Extract 1 in the Light Dark Box Test in the Mouse

The method, which detects anxiolytic activity, follows that described by Crawley, 1981 Pharmacol. Biochem. Behav., 15: 695-699. Anxiolytics increase the time spent in the light compartment.

Animals were placed into the light compartment of a 2-compartment box with one half light and open (25×27×27 cm) and the other half dark and closed (20×27×27 cm). The time spent in each compartment, as well as the number of times the animal crosses from one side to the other, is scored during a 3-minute test. 15 mice were studied per group. The test was performed blind.

Oregano extract 1 was evaluated at 3 doses (10, 30 and 60 mg/kg), administered i.p. 30 minutes before the test, and compared with a vehicle control group. Oregano extract 1 was dissolved in a saline solution containing 3% (v/v) DMSO and 3% (v/v) Tween® 80 (“vehicle”). The control group was administered vehicle, venlafaxine (16 mg/kg i.p) was used as comparison substance and clobazam (16 mg/kg i.p) was used as reference substance, all being administered i.p., 30 minutes prior to the test.

TABLE 5
Result of the Light Dark Box Test in the mouse

| | TIME SPENT IN LIGHT | | | NUMBER OF | | |
|---|---|---|---|---|---|---|
| | COMPARTMENT (s) | | | CROSSINGS | | |
| TREATMENT | | % change | | | % change | |
| (mg/kg) | mean ± | from | | mean ± | from | |
| i.p. − 30 min | s.e.m. | control | | s.e.m. | control | |
| Vehicle | 55.3 ± 6.3 | | — | 4.7 ± 1.1 | | — |
| Oregano extract 1 | 70.7 ± 7.5 | NS | +28% | 7.1 ± 0.9 | NS | +51% |
| (10) | | | | | | |
| Oregano extract 1 | 56.8 ± 5.8 | NS | +3% | 3.2 ± 0.7 | NS | −32% |
| (30) | | | | | | |
| Oregano extract 1 | 74.9 ± 7.2 | NS | +35% | 3.5 ± 0.6 | NS | −26% |
| (60) | | | | | | |
| Venlafaxine (16) | 55.2 ± 9.3 | NS | 0% | 4.4 ± 0.9 | NS | −6% |
| Clobazam (16) | 118.4 ± 3.4 | *** | +114% | 7.9 ± 0.9 | * | +68% |

15 mice per group
Student's t-test:
NS = not significant;
* = p < 0.05;
*** = p < 0.001

Oregano extract 1 at 10 and 60 mg/kg increased the time spent in the light compartment, as compared with vehicle control (+28%, and +35%, p=0.0506 respectively, close to significance). It tended to increase the number of crossings at 10 mg/kg (+51%, p=0.0888) but had no clear effects at 30 and 60 mg/kg. Thus it may be assumed that oregano extract 1 has a moderate anxiolytic effect, as measured in the light-dark box test in the mouse.

### Example 11

### Effect of Oregano Extract 4 in Porsolt's Forced Swim Test in the Mouse after Subchronic, Oral Gavage

This test, which detects antidepressant activity, was performed in the same manner as that described in example 7, except that the route of administering the compound and the doses were different. Oregano extract 4 was evaluated at 3 doses (75, 150, and 300 mg/kg), administered orally (p.o.) 24, 5, and 1 hour before the test, and compared with a vehicle control group. The thus administered oregano extract 1 was dissolved in tocopherol-stripped corn oil “vehicle”). The control group was administered vehicle (p.o.), while imipramine (32 mg/kg, p.o.; dissolved in water) was administered to a separate group as reference compound, 24, 5 and 1 h prior to the test.

Mice were individually placed in cylinders (Height=24.5 cm, Diameter=19.5 cm) containing 13.5 cm water (22° C.) from which they could not escape. The mice were placed in the water for 6 minutes, automatically viewed via a video camera and monitored by a commercially available software system (VideoMot2, TSE Systems GmbH, Germany), and the duration of immobility during the last 4 minutes was measured.

10 mice were studied per each of the five groups. Data were analyzed by comparing the treated groups and the positive control group with the vehicle group using Analysis of Variance (ANOVA) and the Bonferroni post-hoc test.

TABLE 6
Results of forced swim test in the mouse after subchronic administration
of three concentrations of oregano extract 1.

| TREATMENT | DURATION OF IMMOBILITY (s) | | |
|---|---|---|---|
| (mg/kg) | Mean ± | % change | |
| p.o.., −24, −5, −1 h | s.e.m. | from control | |
| Vehicle | 129.35 ± 11.10 | — | — |
| Oregano extract 1 (75) | 76.74 ± 46.02 | −41% | * |
| Oregano extract 1 (150) | 87.79 ± 14.08 | −32% | * |
| Oregano extract 1 (300) | 102.06 ± 13.69 | −21% | NS |
| Imipramine (32) | 64.59 ± 8.26 | −50% | *** |

10 mice per group
Student's t-test:
NS = not significant;
* = p < 0.05;
*** = p < 0.001

Thus, oregano extract 4 significantly reduced immobility time, compared with the control group, by 41% and 32% in the low- and intermediate-dose groups, respectively. Overall, there was a significant effect of oregano extract 4. Imipramine (32 mg/kg i.p.), administered under the same experimental conditions, significantly reduced immobility behavior, as compared with the vehicle control (−50%, p<0.001).

These results show that oregano extract 4 (75 and 150 mg/kg, p.o.) has a similar efficacy as the tricyclic antidepressant, imipramine, in its ability to significantly reduce depression-related behavior.

### Example 12

### Effect of Oregano Extract 4 on Hippocampal Serotonin Levels Measured by In Viva Microdialysis

Male Sprague-Dawley rats (250-320 g) were housed in groups of 4-5 under conditions of controlled temperature (21±2° C.) and humidity (55±10%) with free access to food and water (lights on 07.00-19.00). Rats were anaesthetised using chloral hydrate (400 mg/kg i.p.) and a single microdialysis probe (BASi type MD2200, 2 mm membrane, 30,000 dalton cut-off) implanted in the dorsal hippocampus using a stereotaxic frame at the following coordinates (rostro-caudal—4.5 mm; media-lateral—2.5 mm; dorso-ventral—4.5 mm from bregma and dura surface according to Paxinos & Watson 6) and fixed in position with dental cement. Body temperature was maintained at 36° C. using a heating pad and monitored via a digital rectal thermometer. The microdialysis probe was perfused with artificial cerebrospinal fluid (aCSF) at 1 μl/min and extracellular monoamine levels determined by collection of perfusate samples every 15 min and assayed using high-performance liquid chromatography (HPLC) with electrochemical detection.

The HPLC mobile phase (0.5 mM EDTA, 0.1M monochloroacetic acid pH 3.1, 0.15 g/L sodium octyl sulphate, 5% acetonitrile, 0.7% tetrahydrofuran) was pumped through the system at 70 μl/min. Monoamines were separated using a reverse-phase 1×100 mm ODS 3 mm microbore column with 5 μl injection loop and detected using a Epsilon electrochemical detector (BAST) with a glassy carbon electrode set at +650 mV versus Ag/AgCl reference electrode. Dialysate peaks were identified by comparing peak elution times with reference standards and quantified according to measurement of peak area using linear regression analysis. The detection limits for 5HT and SHIAA were defined as the sample amount producing a peak area twice that of the background noise per unit time and were approximately 0.1 fmol/sample in both cases.

Preliminary studies demonstrated that following implantation of the dialysis probe, the 5HT level was initially high due to release from platelets activated by blood clotting caused by the surgery but within 150 min of completion of the surgery the basal 5HT level was almost constant. Injections were therefore routinely administered at 150, 210 and 270 min following the surgery and perfusate samples collected until 60 min following the final injection.

For routine assay, two rats were prepared of which one was used to test the oregano extract and the other a control (vehicle) sample. Because of the variability in the basal release of 5HT between assays and variability in the efficiency of the microdialysis probes to detect 5HT in the extracellular fluid, these data were normalised according to the 2 values obtained immediately prior to the first injection (namely samples at 135 and 150 min time-points). Data from replicate studies for each compound are therefore expressed as % Basal level, as is normal practice for microdialysis studies. To determine the effect of each dose of the extract on the total amount of 5HT released, the area-under-the-curve (AUC) was estimated using the trapezoid method over the sampling period following each dose administration and values for the test compound/extract compared to the appropriate control by 2-way ANOVA (test factors being Treatment and Dose) followed by post-hoc comparisons at individual doses using the Bonferroni t-test. All statistical analyses were carried out using Graphpad Prism.

Oregano extract 4 (10, 30 and 60 mg/kg, i.p.) was dissolved in saline containing 0.2% (w/v) hydroxypropylmethylcellulose, while the reference compound, fluoxetine (3, 10 and 30 mg/kg, i.p.) was dissolved in saline. Two control groups were additionally investigated, being administered saline containing 0.2% (w/v) hydroxypropylmethylcellulose or saline alone, respectively.

TABLE 7
Effect of Oregano Extract 1 on cumulative 5HT in each dosing
period and expressed relative to the basal 5HT level measured
immediately before injection of the first dose of compound.

| | Time of | 5-HT LEVEL (% basal) | | |
|---|---|---|---|---|
| TREATMENT | injection post- | Mean ± | Statistical | |
| (mg/kg) | surgery (min) | s.e.m. | significance | |
| Saline | 150 | 84 ± 4 | | |
| | 210 | 71 ± 9 | | |
| | 270 | 65 ± 7 | | |
| 0.2% (w/v) hydroxypropyl- | 150 | 80 ± 7 | | |
| methyl cellulose in saline | 210 | 68 ± 4 | | |
| | 270 | 67 ± 5 | | |
| Oregano extract 4 (10) | 150 | 88 ± 3 | † | |
| Oregano extract 4 (30) | 210 | 82 ± 5 | † | |
| Oregano extract 4 (60) | 270 | 75 ± 5 | † | |
| Fluoxetine (3) | 150 | 85 ± 4 | ††† | |
| Fluoxetine (10) | 210 | 131 ± 9 | ††† | *** |
| Fluoxetine (30) | 270 | 160 ± 7 | ††† | *** |

Injections were performed at 150, 210 and 270 min after surgery. The dose of each compound is expressed as mg/kg. Data are expressed as mean ± s.e.m. (n = 5-6). Statistical analysis for each dose of compound is compared against the corresponding time-period for the appropriate vehicle, either saline or saline + 0.2% hydroxypropylmethylcellulose using the Bonferroni t-test and for each compound overall by two-way ANOVA.
5-6 rats per group
Two-way ANOVA: vs. saline control group, overall;
† p < 0.05,
††† p < 0.001
Bonferroni post-hoc test: vs. saline control group;
*** p < 0.001

Estimation of the cumulative 5HT release measured as AUC in the 60 min following administration of each dose of treatment (Table 7) as analysed by 2-way ANOVA also indicated a significant overall effect of treatment with oregano extract 4 (F(1,30)=5.61; p<0.05).

### Example 13

### Dopamine Uptake Inhibition by the Oregano Extract 1

The actions of several neurotransmitters, including dopamine, are regulated through their rapid uptake and clearance from synaptic junctions by plasma membrane transport proteins. The dopamine transporter in central dopaminergic neurones is responsible for the recovery of up to 90% of released neurotransmitter. The monoamine transporters are high affinity targets for a number of psychoactive agents such as cocaine, amphetamine, and antidepressants. These agents, by blocking transporters and consequently preventing neuronal uptake, elevate levels of extracellular neurotransmitter concentrations in both the central and peripheral nervous system, contributing to their behavioral and autonomic effects.

CHO-Ki/hDAT cells expressing the human dopamine transporter (hDAT) were plated before the assay. Cells (2×10⁵/ml) were incubated with oregano extract and/or vehicle in modified Tris-HEPES buffer pH 7.1 at 25° C. for 20 minutes before addition of 50 nM [³H]Dopamine for 10 minutes. Specific signal was determined in the presence of 10 μM nomifensine. Cells were then solubilized with 1% SDS lysis buffer. Reduction of [³H]Dopamine uptake by 50 percent or more (≧50%) relative to vehicle controls indicates significant inhibitory activity. Pure compounds (nomifensine thymoquinol) were screened at 10 concentrations up to 100 μM: 0.00316, 0.01, 0.0316, 0.1, 0.316, 1, 3.16, 10, 31.6 and 100 M. The oregano extract was screened at 10 concentrations up to 100 μg/ml: 0.00316, 0.01, 0.0316, 0.1, 0.316, 1, 3.16, 10, 31.6 and 100 μg/ml. These same concentrations were concurrently applied to a separate group of untreated cells and evaluated for possible compound-induced cytotoxicity only if significant inhibition of uptake was observed.

TABLE 8
Measured IC₅₀ values for inhibition of dopamine reuptake
into transfected CHO-Ki cells by oregano extract
1, and its volatile component thymoquinol.

| Compound | IC₅₀ | |
|---|---|---|
| *Nomifensine | 11 | nM |
| thymoquinol | 65.6 ± 1.2 | μM (n = 2)* |
| Oregano extract 1 | 6.3 | μg/ml |

Data is shown as mean ± s.e.m., where the IC₅₀ is stated as μM (or nM) for single compounds and as μg/ml for the oregano extract.
*Indicates standard reference agent used.

### REFERENCES

Giros, et al. 1992 Mol. Pharmacol. 42: 383-390
Pristupa, et al 1994 Mol. Pharmacol. 45:125-135

### Example 14

### Noradrenaline Uptake Inhibition by the Oregano Extract

The actions of several neurotransmitters, including noradrenaline, are regulated through their rapid uptake and clearance from synaptic junctions by plasma membrane transport proteins. The noradrenaline transporter in central adrenergic neurones is responsible for the recovery of up to 90% of released neurotransmitter. The monoamine transporters are high affinity targets for a number of psychoactive agents such as cocaine, amphetamine, and antidepressants. These agents, by blocking transporters and consequently preventing neuronal uptake, elevate levels of extracellular neurotransmitter concentrations in both the central and peripheral nervous system, contributing to their behavioral and autonomic effects.

Human recombinant noradrenaline transporter stably expressed dog kidney MDCK cells were plated one day before the assay. The cells (2×10⁵/ml) were preincubated with the oregano extract and/or vehicle in modified Tri-HEPES buffer pH 7.1 at 25° C. for 20 minutes, then 25 nM [³H]noradrenaline was added for 10 minutes incubation. Cells in the well were then rinsed twice, solubilized with 1% SDS lysis buffer and the lysate was counted to determine [³H]noradrenaline uptake. Specific signal was determined in the presence of 10 μM desipramine. Reduction of [³H]noradrenaline uptake by 50 percent or more (≧50%) relative to vehicle controls indicates significant inhibitory activity. Pure compounds (desipramine were screened at 10 concentrations up to 100 μM: 0.00316, 0.01, 0.0316, 0.1, 0.316, 1, 3.16, 10, 31.6 and 100 μM. The oregano extract 1 was screened at 10 concentrations up to 100 μg/ml: 0.00316, 0.01, 0.0316, 0.1, 0.316, 1, 3.16, 10, 31.6 and 100 μg/ml. These same concentrations were concurrently applied to a separate group of untreated cells and evaluated for possible compound-induced cytotoxicity only if significant inhibition of uptake was observed.

TABLE 9
Measured IC₅₀ values for inhibition of noradrenaline reuptake
into transfected MDCK cells by oregano extract 1.

| Inhibitor | IC₅₀ | |
|---|---|---|
| *Desipramine | 1.9 | nM |
| Oregano extract | 13.6 | μg/ml |

Data is shown as mean ± s.e.m., where the IC₅₀ is stated as nM for single compounds and as μg/ml for the oregano extract.
*Indicates standard reference agent used.

### REFERENCES

Galli, et al. 1995. J. Exp. Biol. 198: 2197-2212

### Example 15

### Measurement of the Plasma Level of Carvacrol

The concentrations of “free” carvacrol (aglycone) and “total” carvacrol (aglycone+conjugated form) were determined in 64 rat plasma samples. 4 male and 4 female rats received a single dose of 800 mg of oregano extract 4 per kg body weight by oral gavage, respectively. The application solution was prepared in corn oil at a concentration of 200 mg extract per gram formulation. Plasma samples were collected at 0, 0.5, 1, 2, 3, 4, 6, 8, 24 hours and 48 hours (terminal) after the gavage application from at least 3 male and 3 female animals.

The sample analysis was performed with a liquid chromatography—tandem mass spectrometry (LC/MS/MS) system, using a column switching system for online cleaning and desalting of the samples.

After addition of internal standard (D2-thymol) and protein precipitation (in case of “free” analyte) or pre-digesting by β-glucuronidase followed by protein precipitation (in case of “total” analyte), the samples were injected on a Waters XTerra™ MS C18 guard-column used as purification column, then transferred onto a Waters XTerra™ C18 column. Detection was performed using tandem mass spectrometry in MRM mode.

Calibration and quality control samples were prepared in 5% Albumin bovine serum solution and human plasma. Day-to-day performance was controlled with the results of quality control (QC) samples within each analytical batch. The lower limit of quantification was set to 10.0 ng/mL for “free” carvacrol and 20.0 ng/mL for “total” carvacrol.

A kinetic study after oral administration of oregano extract 4 to male and female rats was performed.

The objective of this analytical study was the determination of “free” and “total” carvacrol concentrations in rat plasma samples. A total of 64 samples were analyzed successfully. The plasma samples were collected at different times after the gavage application. The administered dose was 800 mg/kg oregano extract 4 in corn oil.

The measured “free” carvacrol concentrations ranged from not detectable to 50100 ng/mL, and “total” carvacrol concentrations from not detectable to 50000 ng/mL.

TABLE 10
Determination of free and total carvacrol in female rat plasma samples

| ID | Sample Name | | | Free Carvacrol | Total Carvacrol |
|---|---|---|---|---|---|
| number | (Sex/# Rat/Time) | | | (ng/mL) | (ng/mL) |
| 1 | F | 1 | 0 | *ND | *ND |
| 2 | F | 1 | 0.5 | 30.9 | 2160 |
| 3 | F | 1 | 1 | 192 | 4220 |
| 4 | F | 1 | 2 | 64.3 | 829 |
| 5 | F | 1 | 3 | 128 | 3540 |
| 6 | F | 1 | 4 | 246 | 4480 |
| 7 | F | 1 | 6 | 135 | 4000 |
| 8 | F | 1 | 8 | 159 | 3810 |
| 9 | F | 1 | 24 | 127 | 5850 |
| 10 | F | 1 | Terminal | *ND | <LOQ = 20.0 ng/mL |
| | | | (48 h) | | |
| 11 | F | 2 | 0 | *ND | *ND |
| 12 | F | 2 | 0.5 | 5120 | 14800 |
| 13 | F | 2 | 1 | 6050 | 18600 |
| 14 | F | 2 | 2 | 840 | 3550 |
| 15 | F | 2 | 3 | 228 | 1780 |
| 16 | F | 2 | 4 | 102 | 1160 |
| 17 | F | 2 | 6 | 91.9 | 1920 |
| 18 | F | 2 | 8 | 1630 | 6800 |
| 19 | F | 2 | 24 | 8.91 | 1530 |
| 20 | F | 2 | Terminal | *ND | <LOQ = 20.0 ng/mL |
| | | | (48 h) | | |
| 21 | F | 3 | 0 | *ND | *ND |
| 22 | F | 3 | 0.5 | 4090 | 11000 |
| 23 | F | 3 | 1 | 3610 | 10000 |
| 24 | F | 3 | 2 | 1360 | 6470 |
| 25 | F | 3 | 3 | 174 | 1360 |
| 26 | F | 3 | 4 | 50.3 | 928 |
| 27 | F | 3 | 6 | 48.3 | 1140 |
| 28 | F | 3 | 8 | <LOQ = 10.0 ng/mL | 541 |
| 29 | F | 3 | 24 | <LOQ = 10.0 ng/mL | 1680 |
| 30 | F | 3 | Terminal | *ND | <LOQ = 20.0 ng/mL |
| | | | (48 h) | | |
| 31 | F | 4 | 0 | *ND | <LOQ = 20.0 ng/mL |
| 32 | F | 4 | 0.5 | 50100 | 50000 |

ND* Not detected
LOQ* below lower limit of quantification:
LOQ* (Free carvacrol) = 10.0 ng/mL
LOQ* (Total carvacrol) = 20.0 ng/mL

TABLE 11
Determination of free and total carvacrol in male rat plasma samples

| ID | Sample Name | | | Free Carvacrol | Total Carvacrol |
|---|---|---|---|---|---|
| Number | (Sex/# Rat/Time) | | | (ng/mL) | (ng/mL) |
| 33 | M | 1 | 0 | *ND | *ND |
| 34 | M | 1 | 0.5 | 1320 | 18700 |
| 35 | M | 1 | 1 | 1820 | 25200 |
| 36 | M | 1 | 2 | 199 | 5590 |
| 37 | M | 1 | 3 | 51.5 | 3010 |
| 38 | M | 1 | 4 | 30.4 | 2750 |
| 39 | M | 1 | 6 | 83.4 | 6290 |
| 40 | M | 1 | 8 | 185 | 8610 |
| 41 | M | 1 | 24 | 68.1 | 8460 |
| 42 | M | 1 | Terminal | *ND | <LOQ = 20.0 ng/mL |
| | | | (48 h) | | |
| 43 | M | 2 | 0 | *ND | *ND |
| 44 | M | 2 | 0.5 | 1530 | 11100 |
| 45 | M | 2 | 1 | 1790 | 13500 |
| 46 | M | 2 | 2 | 166 | 1260 |
| 47 | M | 2 | 3 | 58.4 | 665 |
| 48 | M | 2 | 4 | 40 | 1040 |
| 49 | M | 2 | 6 | 980 | 8080 |
| 50 | M | 2 | 8 | 156 | 2780 |
| 51 | M | 2 | 24 | <LOQ = 10.0 ng/mL | 1820 |
| 52 | M | 2 | Terminal | *ND | <LOQ = 20.0 ng/mL |
| | | | (48 h) | | |
| 53 | M | 3 | 0 | *ND | *ND |
| 54 | M | 3 | 0.5 | 103 | 2310 |
| 55 | M | 3 | 1 | 1150 | 8550 |
| 56 | M | 3 | 2 | 584 | 6380 |
| 57 | M | 3 | 3 | 1580 | 11200 |
| 58 | M | 3 | 4 | 316 | 2900 |
| 59 | M | 3 | 6 | 100 | 2040 |
| 60 | M | 3 | 8 | 140 | 3630 |
| 61 | M | 3 | 24 | <LOQ = 10.0 ng/mL | 2750 |
| 62 | M | 3 | Terminal | *ND | <LOQ = 20.0 ng/mL |
| | | | (48 h) | | |
| 63 | M | 4 | 0 | *ND | *ND |
| 64 | M | 4 | 0.5 | 55.9 | 4960 |

ND* Not detected
LOQ* below lower limit of quantification:
LOQ* (Free carvacrol) = 10.0 ng/mL
LOQ* (Total carvacrol) = 20.0 ng/mL

### Example 16

### Preparation of a Soft Gelatin Capsule

A soft gelatin capsule may be prepared comprising the following ingredients:

| Ingredient | Amount per Capsule |
|---|---|
| Oregano extract | 500 mg |
| Lecithin | 50 mg |
| Soy bean oil | 250 mg |

Two capsules per day for 3 months may be administered to a human adult for the treatment of mild chronic dysthymia. Similar supplementation time or shorter times (such as 1 week) can be given to increase vigilance. The capsules may be packaged in a kit form, containing a package insert with dosage information. Alternatively, the kit may contain the capsules in a package with such information printed on the packaging. Preferably the packaging is a soft cardboard carton.

### Example 17

### Preparation of a Soft Gelatin Capsule

A soft gelatin capsule may be prepared comprising the following ingredients:

| Ingredient | Amount per Capsule |
|---|---|
| Oregano extract | 200 mg |
| Evening primrose oil | 300 mg |
| Vitamin B₆ | 100 mg |

One capsule per day, preferably during the second half of the menstrual cycle, may be taken for 14 days for the treatment of premenstrual syndrome and premenstrual dysphoric disorder. Similar supplementation time or shorter times (such as 1 week) can be given to increase vigilance. The capsules may be packaged in a kit form, containing a package insert with dosage information. Alternatively, the kit may contain the capsules in a package with such information printed on the packaging. Preferably the packaging is a soft cardboard carton.

### Example 18

### Preparation of an Instant Flavored Soft Drink

| Ingredient | Amount [g] |
|---|---|
| Oregano extract | 0.9 |
| Sucrose, fine powder | 922.7 |
| Ascorbic acid, fine powder | 2.0 |
| Citric acid anhydrous powder | 55.0 |
| Lemon flavor | 8.0 |
| Trisodium citrate anhydrous powder | 6.0 |
| Tricalciumphosphate | 5.0 |
| β-Carotene 1% CWS from DNP AG, | 0.4 |
| Kaiseraugst, Switzerland | |
| Total amount | 1000 |

All ingredients are blended and sieved through a 500 μm sieve. The resulting powder is put in an appropriate container and mixed in a tubular blender for at least 20 minutes. For preparing the drink, 125 g of the obtained mixed powder are mixed with sufficient water to produce one liter of beverage.

The ready-to-drink soft drink contains ca. 30 mg oregano extract per serving (250 ml). As a strengthener and for general well-being and to increase vigilance, 2 servings per day (240 ml) is recommended.

### Example 19

### Preparation of a Fortified Non-Baked Cereal Bar

| Ingredient | Amount [g] |
|---|---|
| Oregano extract | 0.95 |
| Sugar | 114.55 |
| Water | 54.0 |
| Salt | 1.5 |
| Glucose syrup | 130.0 |
| Invert sugar syrup | 95.0 |
| Sorbitol Syrup | 35.0 |
| Palm kernel fat | 60.0 |
| Baking fat | 40.0 |
| Lecithin | 1.5 |
| Hardened palm-oil | 2.5 |
| Dried and cut apple | 63.0 |
| Cornflakes | 100.0 |
| Rice crispies | 120.0 |
| Wheat crispies | 90.0 |
| Roasted hazelnut | 40.0 |
| Skimmed milk powder | 45.0 |
| Apple flavor 74863-33 | 2.0 |
| Citric acid | 5.0 |
| Total amount | 1000 |

Oregano extract is premixed with skimmed milk powder and placed in a planetary bowl mixer. Cornflakes and rice crispies are added and is mixed gently. Then the dried and cut apples are added. In a first cooking pot sugar, water and salt are mixed in the amounts given above (solution 1). In a second cooking pot glucose-, invert sugar- and sorbitol-syrups are mixed in the amounts given above (solution 2). A mixture of baking fat, palm kernel fat, lecithin and emulsifier is the fat phase. Solution 1 is heated to 110° C. Solution 2 is heated to 113° C. and then cooled in a cold water bath. Afterwards solutions 1 and 2 are combined. The fat phase is melted at 75° C. in a water bath. The fat phase is added to the combined mixture of solutions 1 and 2. Apple flavor and citric acid are added to the liquid sugar-fat mix. The liquid mass is added to the dry ingredients and mixed well in the planetary bowl mixer. The mass is put on a marble plate and rolled to the desired thickness. The mass is cooled down to room temperature and cut into pieces. The non-baked cereal bar contains ca. 25 mg oregano extract per serving (30 g). To increase vigilance, 1-2 cereal bars may be eaten per day for 1-2 weeks.

### Example 20

### Dry Dog Feed Comprising Oregano Extract or its Volatile Components for Relieving Stress and Revitalizing the Dog

Commercial basal diet for dogs (e.g. Mera Dog “Brocken”, MERA-Tiernahrung GmbH, Marienstraβe 80-84, D-47625 Kevelaer-Wetten, Germany) is sprayed with a solution of oregano extract in an amount sufficient to administer to a subject a daily dose of 50 mg per kg body weight, based on the weight of the oregano extract or its volatile components concentrate. The food composition is dried to contain dry matter of about 90% by weight. For an average dog of 10 kg body weight to consume approx. 200 g dry feed per day, the dog food contains approx. 2500 mg oregano extract or its volatile components/kg food. For heavier dogs, the feed mix is prepared accordingly. A daily intake for 1-2 weeks is recommended to increase vigilance.

### Example 21

### Wet Cat Food Comprising Oregano Extract or its Volatile Components

Commercial basal diet for cats (e.g. Happy Cat “Adult”, Tierfeinnahrung, Südliche Hauptstraβe 38, D-86517 Wehringen, Germany) is mixed with a solution of oregano extract or its volatile components in an amount sufficient to administer to a subject a daily dose of 100 mg per kg body weight, based on the weight of the dried oregano extract or its volatile components concentrate. For an average cat of 5 kg of body weight to consume approx. 400 g of wet food, the cat food contains 1250 mg/kg oregano extract. The food composition is dried to contain dry matter of about 90% by weight. A daily intake for 1-2 weeks is recommended to increase vigilance.

### Example 22

### Dog Treats Containing Oregano Extract

Commercial dog treats (e.g. Mera Dog “Biscuit” for dogs as supplied by Mera Tiernahrung GmbH, Marienstrasse 80-84, 47625 Kevelaer-Wetten, Germany) are sprayed with a solution of oregano extract or its volatile components in an amount sufficient to administer to the treats 5-50 mg per g treats, based on the weight of the dried oregano extract or its volatile components concentrate. The food composition is dried to contain dry matter of about 90% by weight.

### Example 23

### Cat Treats Containing Oregano Extract

Commercial cat treats (e.g. Whiskas Dentabits for cats as supplied by Whiskas, Masterfoods GmbH, Eitzer Str. 215, 27283 Verden/Aller, Germany) are sprayed with a solution of oregano extract or its volatile components in an amount sufficient to administer to the treats 5-50 mg per g treats, based on the weight of the dried oregano extract or its volatile components concentrate. The food composition is dried to contain dry matter of about 90% by weight.

### Example 24

### Assessing Effects of Oregano Extract on Neuronal Function by Quantitative Wake and Sleep EEG and Wake ERP in a Human Clinical Trial

In a single center, randomized, placebo controlled, cross-over human clinical trail on 20 healthy young male volunteers, the effects of three different doses of oregano extract (purchased from Flavex Gmbh, Rehlingen, Germany) (30 mg/60 mg/120 mg) on brain activity in a wake situation was tested against placebo with the method of quantitative Electro-Encephalogram (qEEG) and Event-Related Potentials (ERPs). In addition, polysomnographic recordings and all night sleep EEG spectral analysis in the 20 volunteers was performed in order to test the effect of oregano extract on sleep after an additional dose of 30 mg, 60 mg or 120 mg of oregano extract.

### Methods:

The 4 successive assessment periods were at least 5 days apart of each other (wash-out periods). At these periods, each subject received one of the 3 doses tested (30 mg, 60 mg or 120 mg) or the placebo as a single assessment. Three subjects did not complete the entire study periods.

At each study day of each period, qEEGs were recorded after dose administrations. In detail: 28 EEG leads were recorded using ear linked references as well as 4 artifact channels (detection of eye movement, muscle activity and other potentials causes of artifacts). EEGs were taken under first 3 minutes vigilance controlled recording (VC) conditions (the subjects are asked to push two knobs during the recording conditions), followed by 3 minutes resting (R) recording conditions (subjects are asked to relax with their eyes closed).

A double baseline was performed at 1 and 0.5 hours before dosing. Only the second baseline was used for analysis, the first one being a training session. Additional qEEG measurements were performed 1, 2, 4 and 6 hours after dosing. Extraction of parameters was carried out on individual spectra by breaking them down into standard frequency EEG bands: Delta (0.5-3.5 Hz), Theta (4-7.5 Hz), Alpha (8-12.5 Hz), and Beta (13-32 Hz). The alpha and the beta bands are also respectively divided in: Alpha 1 (8-9.5 Hz) and alpha 2 (10-12.5 Hz) and beta 1 (13-17.5 Hz), beta 2 (18-20.5 Hz) and beta 3 (21-32 Hz).

In addition, ERP measurements were performed. This ERP was based on the standard auditory P300 “odd-ball” paradigm. Each subject listened to a series of two tones, with a frequency of 500 Hz for frequent tones and a frequency of 2000 Hz for infrequent or target tones. Subjects were asked to count the infrequent tones. By this counting, a peak appeared in the EEG after about 300 ms. From this peak, the P300 amplitude, latency on Cz (central) electrode as well as 5300 (area under the P300 waveform) on all electrodes can be determined. Auditory P300 measurement time points were the same as for qEEG.

In the evening of each study day, the study volunteers got a second dose of the oregano extract (30 mg/60 mg/120 mg) or placebo and underwent polynomnography recording (sleep EEG) two hours later for the whole night (8 hours). Each treatment night was preceded by a habituation night that was not analyzed due to the first-night effect issue, i.e. difficulties in initiating and/or maintaining sleep that healthy subjects generally experience during a first recorded night in an unusual setting. Sleep stages were visually scored for the complete recording period (from 11:00 p.m. to 7:00 a.m.) at 30 sec intervals in either stage 0 (wake), stage 1, stage 2, stage 3, stage 4, stage 5 (rapid eye movement [REM] sleep) or stage 6 (movement time). The different visual sleep parameters were derived from the visual scoring of the recordings using the Hypnos software.

### Results:

### EEG:

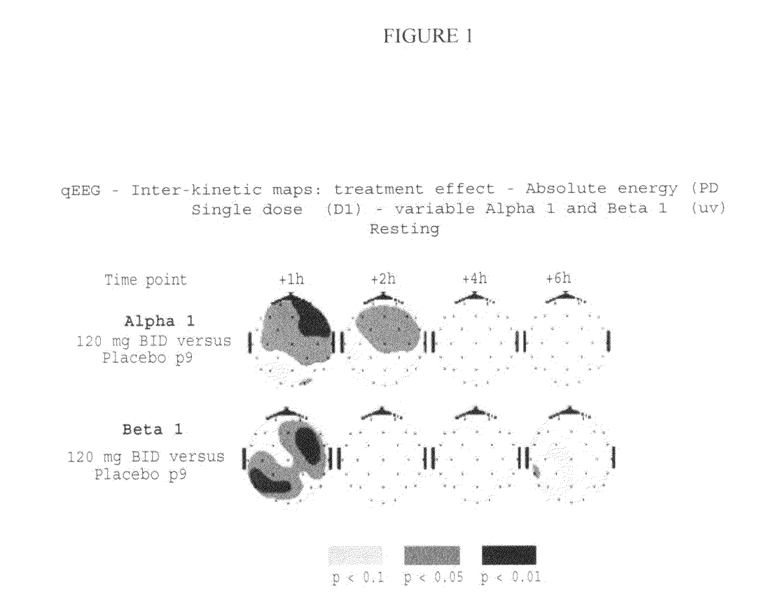

Quantified EEG recording and analysis was followed by a systematic evaluation method to search for compound-induced effects. These analyses revealed that in the wake qEEG, transient significant increases (p<0.05) in absolute power in the resting condition of alpha-1 and beta-1 EEG parameters have occurred for the 120 mg dose lasting for more than one hour (FIG. 1). Also at two hours after intake of the 120 mg dose of oregano extract, the alpha-1 wave was increased in comparison to placebo, although not statistically significant anymore (p<0.1).

### ERP:

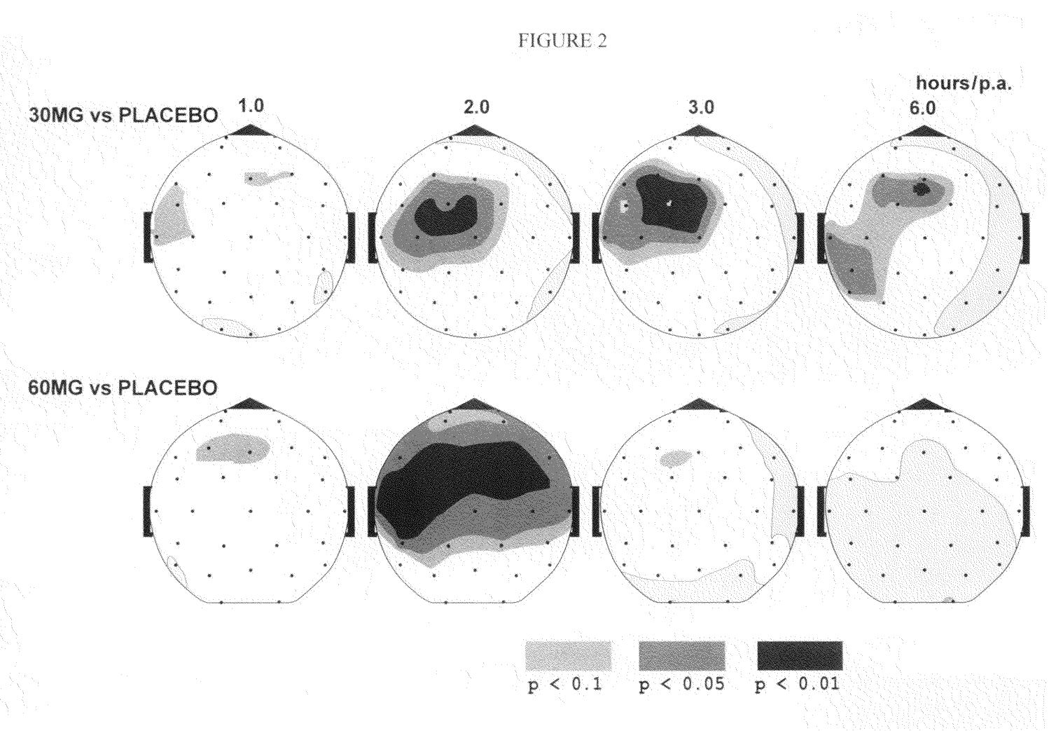

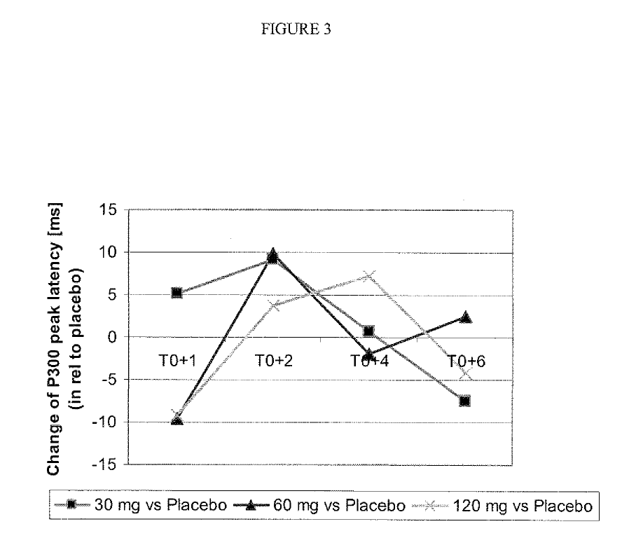

Analyses of the P300 peak latency and amplitude on the vertex lead showed some significant modifications by the oregano extract in comparison to placebo. Most evident were the increases in P300 amplitude maps for the 30 mg oregano extract dose over left frontal and central cranial regions, but most pronounced for the 60 mg oregano extract dose over the anterior half of the brain compared with placebo. These modifications started to occur between 1-2 hours after oregano extract intake and lasted up to 6 hours in the case of the 30 mg dose and up to 2-3 hours for the 60 mg dose (FIG. 2). In addition, the P300 peak latencies were decreased one hour after intake of the 60 mg and the 120 mg oregano extract dose compared with placebo. This was not statistically significant, but a trend (border line significance) is observed (FIG. 3).

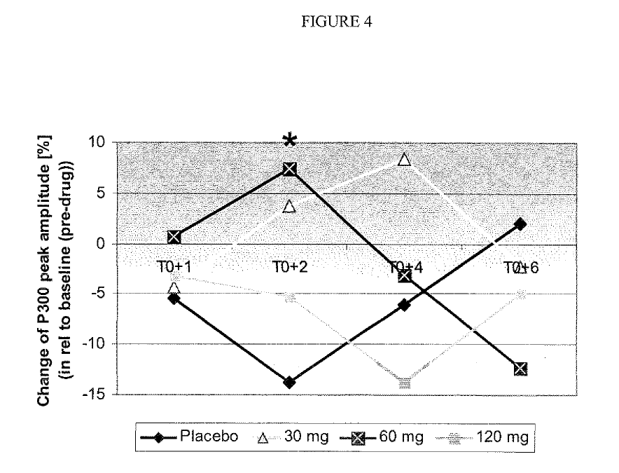

When looking solely at the P300 peak amplitudes on the vertex lead (central lead on the scalp), 60 mg oregano extract significantly increased the P300 amplitude by 7.4% compared with baseline, and 21.2% compared with placebo after 2 hours intake (FIG. 4).

The 30 mg dose increased the P300 amplitude for up to 8% compared with baseline and 15% compared with placebo after four hours of intake, but this was not statistically significant. Interestingly, the amplitudes in the placebo group were decreased 2 hours after placebo intake, which resembles a circadian decline in attention (before and after lunch). The 60 mg (and to a certain extent also the 30 mg) oregano extracts were able to alleviate this decline and to even increase the P300 amplitudes to higher levels than at baseline. Therefore, the obtained results with the oregano extract indicate that oregano extract stimulates attention and helps to alleviate the daily decline in attention usually experienced at mid-day.

### Sleep EEG:

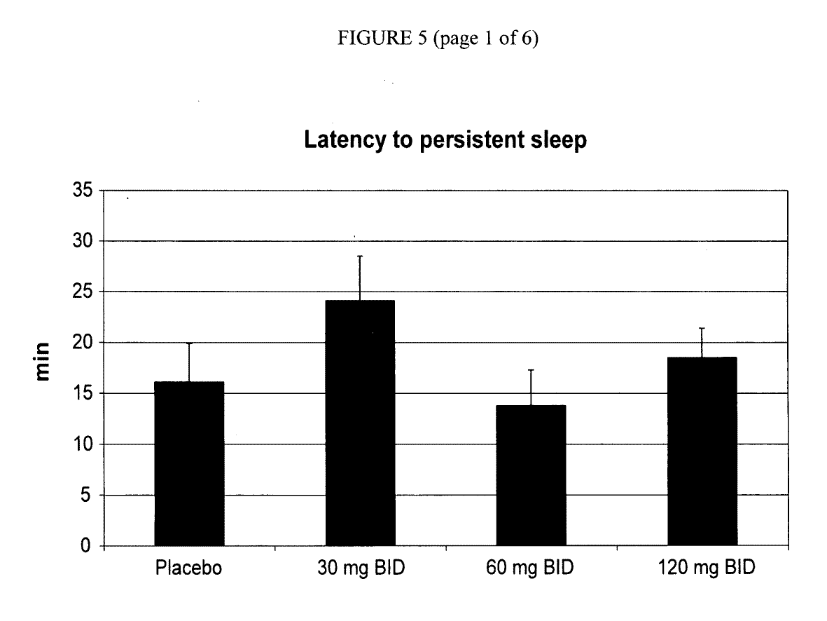

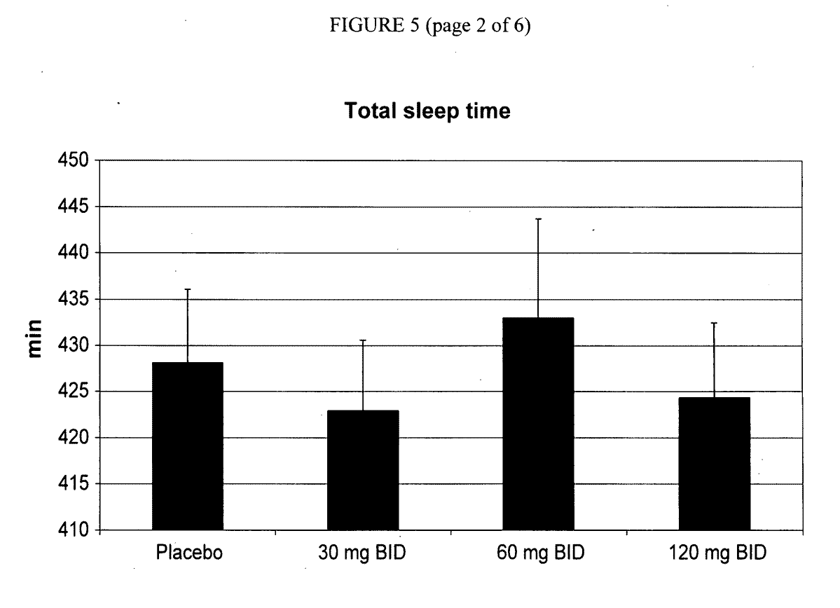

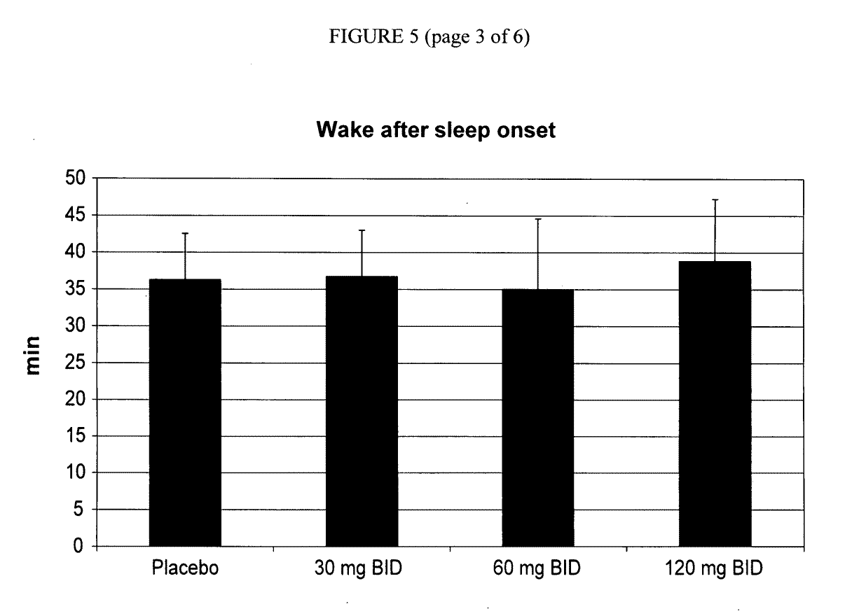

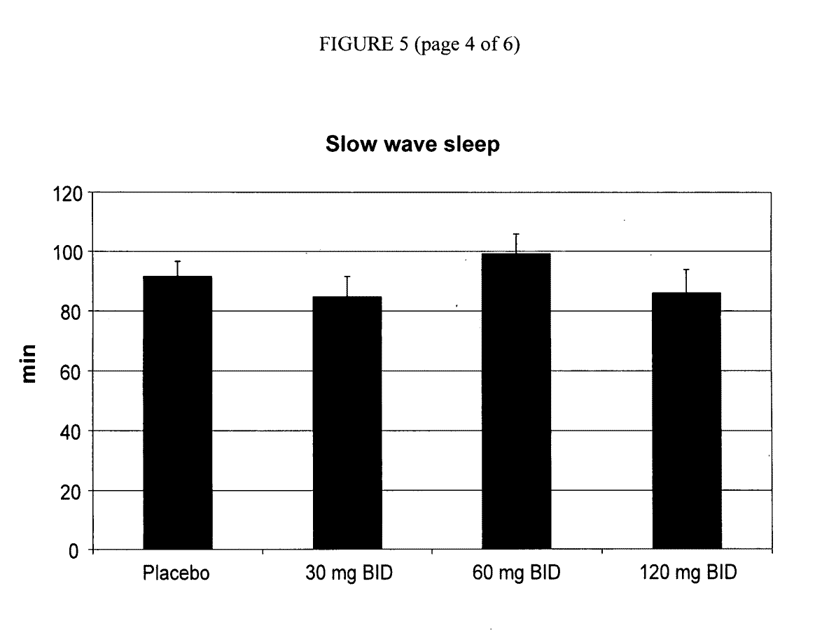

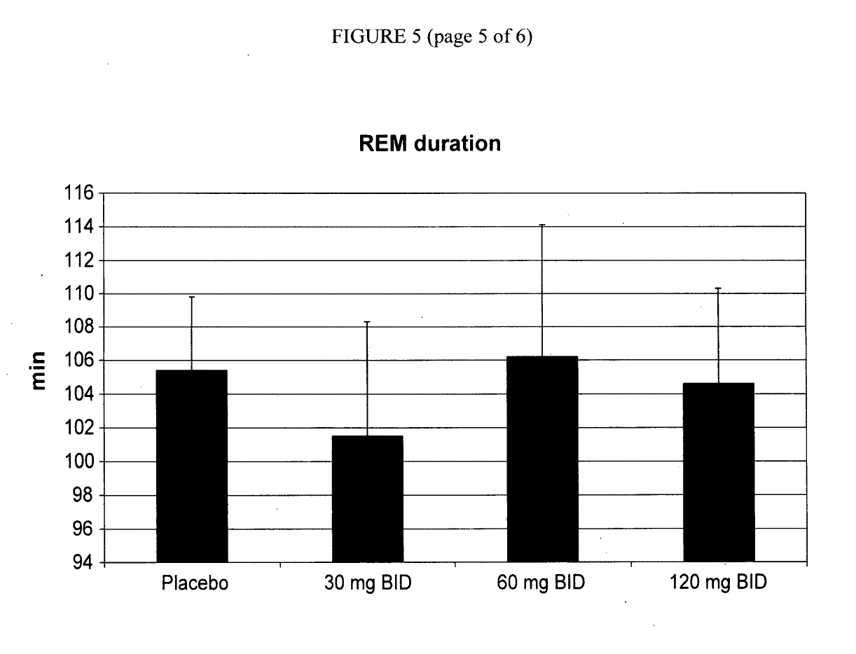

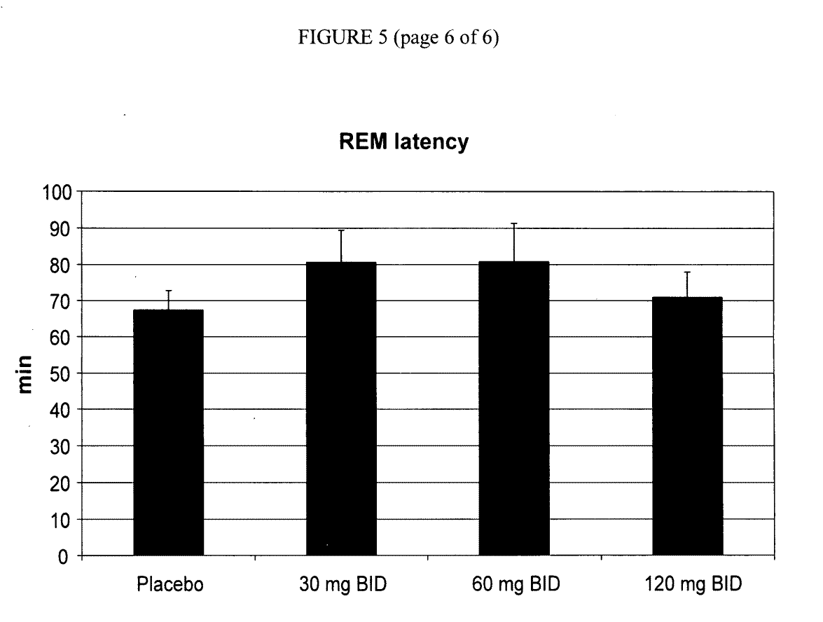

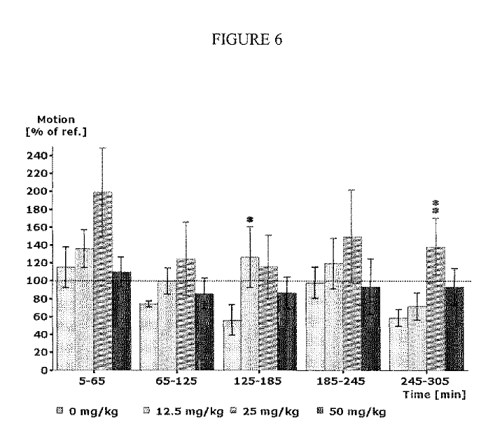

In order to test if the oregano extract influences sleep continuity or architecture, polysomnography recordings were done. Polysmnopgraphy data recording started two hours after the second intake of the study compound at the study day. After analyzing the entire set of sleep parameter data of all subjects, no deleterious effects on sleep continuity or architecture were observed (FIG. 5).

It has been found, in accordance with this invention, that oregano extract and its active ingredients are able to significantly increase alpha-1 and beta-1 EEG parameters (absolute energy) in the resting condition of alpha-1 and beta-1 EEG parameters with a dose of 120 mg for up to two hours. Also the P300 surface peak amplitude (S300) was significantly increased for the 30 and 60 mg dose, occurring after one hour and returning to baseline level after 6 hours. Further, P300 peak amplitudes on the vertex lead were significantly increased 2 hours after 60 mg oregano extract administration in comparison to the placebo (+22%). Also compared with baseline, the 60 mg dose significantly increased the P300 amplitude (+7%) on the vertex lead after two hours. In addition, the P300 peak latencies showed a trend to be decreased one hour after intake of the 60 mg and the 120 mg oregano extract dose compared with placebo (−10 ms).

An increase in alpha activity has been associated with relaxation, increased creativity, increased performance under stress and improved learning and concentration, as well as decreased anxiety^{5,6}. An increase in beta activity is related to higher cortical activation⁸, an increased state of alertness⁷ and cognitive processing⁹.

### Example 25

### Preparation of Liquid Capsules (LiCaps)

Liquid capsules (LiCaps) may be prepared comprising the following ingredients:

| Oregano extract Dosage | 30 mg | 60 mg | 120 mg |
|---|---|---|---|
| Oregano extract per capsule (mg) | 34.5 mg | 69 mg | 138 |
| Tricylglycerol (Durkex 200) (mg) | 420 | 420 | 420 |
| Phosphatidylcholine (mg) | 265.5 | 231 | 162 |
| Total per capsule (mg) | 720 | 720 | 720 |

The capsules may be packaged in a kit form, containing a package insert with dosage information. Alternatively, the kit may contain the capsules in a package with such information printed on the packaging. Preferably the packaging is a soft cardboard carton.

### REFERENCES

### Each of the Following is Hereby Incorporated by Reference

1. Davis, M. & Whalen, P. J. The amygdala: vigilance and emotion. Mol Psychiatry 6, 13-34 (2001).
2. Hegerl, U. et al. EEG-vigilance differences between patients with borderline personality disorder, patients with obsessive-compulsive disorder and healthy controls. Eur Arch Psychiatry Clin Neurosci 258, 137-43 (2008).
3. Klerman, E. B., Boulos, Z., Edgar, D. M., Mistlberger, R. E. & Moore-Ede, M. C. EEG delta activity during undisturbed sleep in the squirrel monkey. Sleep Res Online 3, 113-9 (2000).
4. Bodizs, R., Sverteczki, M. & Meszaros, E. Wakefulness-sleep transition: emerging electroencephalographic similarities with the rapid eye movement phase. Brain Res Bull 76, 85-9 (2008).
5. Eschenauer, G. & Sweet, B. V. Pharmacology and therapeutic uses of theanine. Am J Health Syst Pharm 63, 26, 28-30 (2006).
6. Boutcher, S. H. & Landers, D. M. The effects of vigorous exercise on anxiety, heart rate, and alpha activity of runners and nonrunners. Psychophysiology 25, 696-702 (1988).
7. Porjesz, B. et al. Linkage and linkage disequilibrium mapping of ERP and EEG phenotypes. Biol Psychol 61, 229-48 (2002).
8. Kubitz, K. A. & Mott, A. A. EEG power spectral densities during and after cycle ergometer exercise. Res Q Exerc Sport 67, 91-6 (1996).
9. Karrasch, M., Laine, M., Rapinoja, P. & Krause, C. M. Effects of normal aging on event-related desynchronization/synchronization during a memory task in humans. Neurosci Lett 366, 18-23 (2004).
10. Kugler, C. F., Taghavy, A. & Platt, D. The event-related P300 potential analysis of cognitive human brain aging: a review. Gerontology 39, 280-303 (1993).
11. Polich, J. & Herbst, K. L. P300 as a clinical assay: rationale, evaluation, and findings. Int J Psychophysiol 38, 3-19 (2000).
12. Polich, J., Howard, L. & Starr, A. P300 latency correlates with digit span. Psychophysiology 20, 665-9 (1983).
13. Schellenberg, R., Sauer, S. & Dimpfel, W. Pharmacodynamic effects of two different hypericum extracts in healthy volunteers measured by quantitative EEG. Pharmacopsychiatry 31 Suppl 1, 44-53 (1998).
14. Rechtschaffen, A. & Kales, A. A manual of standardized terminology techniques and scoring system for sleep stage of human subjects. Washington D.C.: National Institute of Health Publication 204 (1968).
15. van Nunen, P. E. & Declerek, A. C. P300, alertness and cognition. Acta Psychiatr Belg 94, 96-7 (1994).
16. Hansenne, M. [The p300 cognitive event-related potential. I. Theoretical and psychobiologic perspectives]. Neurophysiol Clin 30, 191-210 (2000).
17. Emmerson, R. Y., Dustman, R. E., Shearer, D. E. & Turner, C. W. P3 latency and symbol digit performance correlations in aging. Exp Aging Res 15, 151-9 (1989).

What is claimed is:

1. A method of increasing alpha-1 and/or beta-1 brain wave activity comprising:
a) administering an effective amount of oregano extract or its active ingredients; and
b) observing an increase in alpha-1 and/or beta-1 brain wave activity.

2. A method according to claim 1 wherein the active ingredients are selected from the group consisting of carvacrol, thymol, thymoquinone, thymoquinol, and mixtures of two or more of the foregoing.

3. A method according to claim 1 where the active ingredients comprise carvacrol and thymoquinine.

4. A method according to claim 1 wherein the oregano extract or its active ingredients are present in a nutraceutical or food.

5. A method according to claim 1 wherein the oregano extract or its active ingredients are present in food, feed, feed premix, fortified food, fortified feed, a tablet, a pill, granules, dragées, a capsule, an effervescent formulation, a powder, a solution, an emulsion or a suspension.

6. A method according to claim 1 wherein the increase in alpha-1 and/or beta-1 brain wave activity is observed by: observing the achievement of a relaxed state combined with wakefulness, alertness, vigilance or focus.

7. A method according to claim 1 wherein the oregano extract is administered between 11:00 AM and 2:00 PM.

8. A method according to claim 1 wherein the effective amount is 25-200 mg/day.

9. A method according to claim 1 wherein the oregano extract or its active ingredients are administered to a non-human animal.

10. A method according to claim 1 wherein the administration is self-administration.

11. A method of improving attention or vigilance while not interfering with sleep patterns comprising:
a) ingesting an effective amount of oregano extract or its active ingredients; and
b) noticing an improvement in attention or vigilance.

12. A method according to claim 11 wherein the active ingredients are selected from the group consisting of carvacrol, thymol, thymoquinone, thymoquinol, and mixtures of two or more of the foregoing.

13. A method according to claim 11 where the active ingredients comprise carvacrol and thymoquinine.

14. A method according to claim 11 wherein the oregano extract or its active ingredients are present in a nutraceutical or food.

15. A method according to claim 11 wherein the oregano extract or its active ingredients are present in food, feed, feed premix, fortified food, fortified feed, a tablet, a pill, granules, dragées, a capsule, an effervescent formulation, a powder, a solution, an emulsion or a suspension.

16. A method according to claim 11 wherein the increase in is observed at while at work, at school, or during sport, entertainment or recreational activities.

17. A method according to claim 11 wherein the oregano extract is administered between 11:00 AM and 2:00 PM.

18. A method according to claim 11 wherein the effective amount is 25-200 mg/day.

19. A method according to claim 11 wherein the oregano extract or its active ingredients are administered to a non-human animal.

20. A method of increasing evoked potential P300 peak amplitude comprising:
a) administration to a subject of an effective amount of oregano extract or its active ingredients; and
b) observing the increased evoked potential P300 peak amplitude.

21. A method according to claim 20 wherein the active ingredients are selected from the group consisting of carvacrol, thymol, thymoquinone, thymoquinol, and mixtures of two or more of the foregoing.

22. A method according to claim 20 where the active ingredients comprise carvacrol and thymoquinine.

23. A method according to claim 20 wherein the oregano extract or its active ingredients are present in a nutraceutical or food.

24. A method according to claim 20 wherein the oregano extract or its active ingredients are present in food, feed, feed premix, fortified food, fortified feed, a tablet, a pill, granules, dragées, a capsule, an effervescent formulation, a powder, a solution, an emulsion or a suspension.

25. A method according to claim 20 wherein the increased evoked potential P300 peak amplitude is observed by: observing the achievement of a relaxed state combined with wakefulness, alertness, vigilance or focus.

26. A method according to claim 20 wherein the oregano extract is administered between 11:00 AM and 2:00 PM.

27. A method according to claim 20 wherein the effective amount is 25-200 mg/day.

28. A method according to claim 20 wherein the oregano extract or its active ingredients are administered to a non-human animal.

29. A method according to claim 20 which is self-administered.

30. A kit for use in increasing vigilance comprising:
a) an effective amount of oregano extract or its active ingredients
b) printed material containing instructions for using a) to increase vigilance.

31. A nutraceutical, food, or food supplement comprising oregano extract or its active ingredients, which when ingested, is observed to promote vigilance in a person.
